(19) United States
(12) Patent Application Publication
(10) Pub. No.: US 2009/0119143 A1
(43) Pub. Date: May 7, 2009

(54) BRAND NOTIFICATION SYSTEMS AND METHODS

(75) Inventors: David Silver, Sparks, NV (US); Daryle S. Fong, Santa Clara, CA (US); Jeff Klein, Oakland, CA (US); P. Garrett Gaudini, San Francisco, CA (US); Andrew Horton, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor Inc., Boise, ID (US)

(21) Appl. No.: 12/349,859

(22) Filed: Jan. 7, 2009

Related U.S. Application Data
(63) Continuation-in-part of application No. 11/550,219, filed on Oct. 17, 2006.
(60) Provisional application No. 61/120,233, filed on Dec. 5, 2008.
(60) Provisional application No. 60/727,891, filed on Oct. 17, 2005.

(51) Int. Cl. G06Q 10/00

(52) U.S. Cl. 705/7

(57) ABSTRACT

Tools and techniques for identifying brand misuse and/or for distributing information about such misuse. Certain of the tools and techniques can be used to determine that a set of online content (e.g., a web site, web page, or portion thereof) is untrustworthy (for example, because that set of online content misuses a brand) and generate a brand notification feed indicating the untrustworthiness of the set of online content. This brand notification feed might be distributed to a security vendor, who can incorporate information from the brand notification feed into the information it provides to clients.

### CROSS-REFERENCES TO RELATED APPLICATIONS

The present disclosure may be related to the following commonly assigned applications/patents:

This application is a nonprovisional application claiming the benefit, under 35 U.S.C. § 119(e), of provisional U.S. Patent Application No. 61/120,233, filed Dec. 5, 2008 by Silver et al. and entitled “Brandcasting Systems and Methods.”

This application is also a continuation-in-part of co-pending U.S. patent application Ser. No. 11/550,219 filed Oct. 17, 2006 by Silver and entitled “Client Side Brand Protection,” which claims the benefit of provisional U.S. Patent Application No. 60/727,891, filed Oct. 17, 2005 by Silver and entitled “Client Side Brand Protection.”

The respective disclosures of these applications/patents are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to Internet technologies, and more particularly, to tools and techniques for providing information about online entities.

### BACKGROUND

As online activity, and in particular online commerce, continues to grow, the incidence of online scams and schemes grows at an equal, if not greater, pace. Fraudsters continually develop new and creative techniques to obtain illicit gains online. Examples range from identity theft (for example, through phishing operations, which attempt to misuse a legitimate brand to lure consumers into a false sense of security), to fraudulent sales of non-existent products, to brand infringement, in which scammers attempt to misappropriate the goodwill of a reputable business in order to sell counterfeit, recalled, and/or grey market goods. While some scammers go to the trouble of maintaining a dedicated online commerce site from which they sell these illegitimate products, other scammers opt to employ otherwise-legitimate sales vehicles, such as auction web sites, community sales lists, microsites (custom websites, sometimes referred to as “exchanges,” hosted by larger online retailers) and the like. In other words, illegitimate brand usage can occur on both illegitimate and otherwise-legitimate online commerce sites.

Such activities harm not only the consumers who are taken in by the scams, but also the brandowners whose brands are tarnished through no fault of their own, but rather by the illicit actions of the scammers. Hence, both consumers and brandowners have a strong interest in ensuring that, when a consumer visits an online commerce site to purchase a product, the product is in fact a genuine, licensed product, and not a cheap knockoff or grey market substitute. There have been attempts by brand protection providers to develop tools and techniques for identifying such illicit activity. Merely by way of example, U.S. patent application Ser. No. 11/550,219, already incorporated by reference, describes methods and systems that provide the ability to identify (e.g., through sophisticated data gathering and scoring techniques) web sites that improperly use a brandowner's brand.

Such information, however, is of limited utility without a reliable mechanism for providing the information to consumers, because it is the consumers who are in a position to take action (e.g., by refusing to purchase from disreputable sellers). There are tools that are designed to provide online security for users (for example, by diagnosing phishing scams and warning users who inadvertently attempt to participate in such scams). Often, these tools take the form of dedicated clients or web browser plugins that monitor a user's online activity and warn of threats as they occur.

Such tools can be effective at protecting users against some types of online fraud, but by themselves, these tools are not very useful for warning consumers about brand infringement. One reason for this ineffectiveness is the fact that security vendors, who are responsible for providing the warning tools, typically do not have access to the brand information that would provide a reliable basis for warning users about improper brand usage. On the other hand, as noted above, brand protection providers, who have developed sophisticated tools and techniques for identifying brand misuse, do not have an effective vehicle for providing that information to users.

Hence, there is a need for tools that allow for the distribution of brand information to the entities that are in a position to use that information.

### BRIEF SUMMARY

Certain embodiments, therefore, provide tools and techniques for identifying brand misuse and/or for distributing information about such misuse. In an aspect, some embodiments determine that a set of online content (e.g., a web site, web page, or portion thereof) is trustworthy (for example, because the set of online content is affiliated, by corporate relationship, license, authorization, or otherwise, with a brandowner with rights to the brand) or is untrustworthy (for example, because that set of online content misuses a brand) and to generate a brand notification feed indicating the (un)trustworthiness of the set of online content. This brand notification feed, in other embodiments, is distributed to a security vendor, who can incorporate information from the brand notification feed into the information it provides to clients (which typically, but not always, will be running on users' computers alongside, or within, web browsers).

In a set of embodiments, the tools provide the ability for a brandowner to review the set of online content to confirm that the content is untrustworthy. This feature can help to reduce false positives. In another set of embodiments, the tools provide a mechanism to address disputes (in which the provider of the set of online content disputes that the content is untrustworthy), for example, by allowing the brandowner to indicate that an improper brand use in the content has been remediated, and by providing an updated brand notification feed indicating the same.

In accordance with further embodiments, the brand notification feed is provided upon request from a brand notification client at the security vendor's computer system. In an aspect, the brand notification feed may be formatted with a structured markup language, and/or the brand notification client may be configured to convert the brand notification feed into an exposed object (such as a Java object, to name one example) for use by the security vendor's computer system. In this way, the structure and/or nature of the brand notification feed itself may be obfuscated from the security vendor, providing enhanced security for the brand protection provider.

The tools provided by various embodiments of the invention include, without limitation, methods, systems, and/or software products. Merely by way of example, a method might comprise one or more procedures, any or all of which are executed by a computer system. Correspondingly, an embodiment might comprise a computer system configured with instructions to perform one or more procedures in accordance with methods provided by various embodiments. Similarly, a computer program might comprise a set of instructions that are executable by a computer system (and/or a processor therein) to perform such operations. In many cases, such software programs are encoded on physical and/or tangible computer-readable media (such as, merely by way of example, optical media, magnetic media, and/or the like).

Merely by way of example, one set of embodiments provides systems, including without limitation systems for providing information about online entities. In one embodiment, a system comprises a brand notification computer system and a security vendor computer system in communication with the brand notification computer system. In an aspect, the brand notification computer system comprises a first processor and a first computer readable medium having encoded thereon a first set of instructions executable by the brand notification computer system to perform one or more operations. In another aspect, the security vendor computer system comprises a second processor and a second computer-readable medium having encoded thereon a second set of instructions executable by the security vendor computer system to perform one or more operations.

In some embodiments, the first set of instructions (on the brand notification computer system) comprises instructions for identifying a suspicious set of online content identified by a URL. The first set of instructions might further comprise instructions for providing a user interface for a user to review information about the set of online content. The user interface, in some aspects, comprises a user interface mechanism for the user to indicate that the set of online content improperly uses a brand owned by a brandowner. The first set of instructions might also comprise instructions for displaying the set of online content for the user, and/or instructions for receiving, via the user interface, first user input indicating that the set of online content improperly uses the brand.

The first set of instructions might further comprise instructions for generating a brand notification indicating that the set of online content includes an improper brand usage. The generation of the brand notification, in some cases, is based at least in part on the first user input. The brand notification might comprise an identification of the URL, an identification of the brand, an identification of the brandowner, and/or an indication of a category describing how or why the set of online content improperly uses the brand.

In further embodiments, the first set of instructions might also comprise instructions for generating a brand notification feed comprising the brand notification and/or instructions for providing the brand notification feed, perhaps upon request from a brand notification client software program at a security vendor computer system. In certain embodiments, the brand notification feed is formatted with a structured markup language. The first set of instructions might also include instructions for displaying, via the user interface, status information about the brand notification.

The second set of instructions, operating on the security vendor computer system, might include instructions for receiving, at a brand notification client software program, a Java object request that requests the brand notification feed from the brand notification computer system. The second set of instructions might also include instructions for converting the Java object request into a brand notification request at the brand notification client software program and/or instructions for transmitting the brand notification request from the brand notification client software program for reception by the brand notification computer system. Correspondingly, the second set of instructions might include instructions for receiving, at the brand notification client software program, the brand notification feed from the brand notification computer system. In some cases, the second set of instructions also includes instructions for converting, at the brand notification client software program, the brand notification feed to a Java object response available to the security vendor computer system In an aspect, the Java object response might comprise information from the brand notification feed.

The second set of instructions, in a set of embodiments, further comprises instructions for providing the Java object response, from the brand notification client software program, for use by the security vendor computer system. There may also be instructions for publishing (e.g., from the security vendor computer system and/or to one or more security clients on user computers), a notification that the URL is suspect. This notification may be based, at least in part, on the information from the brand notification feed;

In some cases there may be a dispute about whether the URL improperly uses the brand Accordingly, the second set of instructions might further comprise instructions for receiving, from a siteowner associated with the set of online content, information disputing that the set of online content includes an improper brand usage. The second set of instructions, in some embodiments, further includes instructions for transmitting, via the brand notification client software program, a notification that the siteowner disputes that the set of online content includes an improper brand usage.

Correspondingly, the first set of instructions operating on the brand notification computer system might include instructions for receiving a notification of a dispute (either from the security vendor or from another entity, such as the siteowner). In some embodiments, the first set of instructions also includes instructions for displaying, via the user interface, an indication that the siteowner disputes that the set of online content includes an improper brand usage, and/or instructions for receiving, via the user interface, second user input indicating a status of the set of online content. The brand notification computer system, then, might also have instructions for updating the brand notification, perhaps based, at least in part, on the second user input, instructions for generating an updated brand notification feed comprising the updated brand notification, and/or instructions for providing the updated brand notification feed upon request from the brand notification client software program at the security vendor computer system.

A computer system in accordance with another set of embodiments comprises a processor and a computer-readable medium having encoded thereon a set of instructions executable by the computer system. In one embodiment, the set of instructions comprises instructions for determining whether a set of online content is untrustworthy, instructions for generating a brand notification indicating whether the set of online content is untrustworthy, and/or instructions for distributing the brand notification. In an aspect, the brand notification might comprise an identification of the set of online content.

A system in accordance with yet another set of embodiments comprises a first computer system having a processor and a first computer readable medium having encoded thereon a first set of instructions executable by the first computer system to perform one or more operations. The first set of instructions includes, in some embodiments, instructions for determining that a set of online content is untrustworthy. In an aspect, the set of online content may be identified by a URL The first set of instructions might further comprise instructions for generating a brand notification feed indicating that the set of online content is untrustworthy. The brand notification feed, in some embodiments, comprises an identification of the URL and/or an indication of a category describing how the set of online content is untrustworthy. In other embodiments, the brand notification feed might be formatted with a structured markup language. The first set of instructions, then, might further include instructions for transmitting the brand notification feed from the brand notification computer system, upon request from a brand notification client software program at a security vendor computer system.

In certain embodiments, the computer system further comprises a brand notification client software program operating on a second computer system, the brand notification client software program comprising a second set of instructions that is executable by the second computer system to perform one or more operations. In an aspect of some embodiments, the brand notification client software program comprises instructions for receiving the brand notification feed, and instructions for providing information from the brand notification feed to the second computer system using an exposed interface. In an aspect, the use of the exposed interface ensures that the brand notification feed formatted in the structured markup language is not accessible by an operator of the second computer system.

Another set of embodiments provides methods. A method in accordance with one set of embodiments comprises determining, at a computer system, whether a set of online content is untrustworthy. For example, in some cases, the method comprises determining that the set of online content is trustworthy, while in other cases, the method comprises determining that the set of content is untrustworthy. The method might further comprise generating, at the computer system, a brand notification indicating whether the set of online content is untrustworthy; in some cases, the brand notification comprises an identification of the set of online content. In an aspect, the method further comprises distributing the brand notification.

A method in accordance with another set of embodiments comprises determining, at a first computer system, that a set of online content (which might be identified by a URL) is untrustworthy. The method might also comprise providing, at a second computer system, a brand notification client software program for receiving a brand notification feed from the first computer system. In an aspect of some embodiments, the method further includes generating, at the first computer system, a brand notification feed indicating that the set of online content is untrustworthy; the brand notification feed, in some aspects, might comprise an identification of the URL and/or an indication of a category describing how the set of online content is untrustworthy. In other aspects, the brand notification feed might be formatted with a structured markup language.

In some embodiments, the method further comprises transmitting the brand notification feed from first computer system, and/or receiving the brand notification feed at the brand notification client. The method might also include providing information from the brand notification feed to the second computer system using an exposed interface, such that the brand notification feed formatted in the structured markup language is not accessible by an operator of the second computer system.

A further set of embodiments provides software programs. An exemplary embodiment provides an apparatus, comprising a computer-readable medium having encoded thereon a set of instructions executable by a computer system. In the exemplary embodiment, the set of instructions includes instructions for determining whether a set of online content is untrustworthy, instructions for generating a brand notification indicating whether the set of online content is untrustworthy, and instructions for distributing the brand notification.

An apparatus in accordance with another set of embodiments might include a first computer-readable medium having encoded thereon a set of instructions executable by a first computer system, and a second computer-readable medium having encoded thereon a brand notification client software program, which comprises a second set of instructions executable by a second computer system (which might be, but need not be a different computer system than the first computer system).

The first set of instructions might comprise instructions for determining that a set of online content is untrustworthy, instructions for generating a brand notification feed indicating that the set of online content is untrustworthy, and/or instructions for transmitting the brand notification feed. In an aspect of some embodiments, the brand notification feed is formatted with a structured markup language. The second set of instructions, then, might comprise instructions for receiving the brand notification feed, and/or instructions for providing information from the brand notification feed to the second computer system using an exposed interface, such that the brand notification feed formatted in the structured markup language is not accessible by an operator of the second computer system.

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a system for providing information about online entities, in accordance with various embodiments of the invention.

FIG. 2 is a process flow diagram illustrating a method of generating a brand notification, in accordance with various embodiments.

FIGS. 3A-3E are exemplary screen displays illustrating a user interface for interacting with a user to generate a brand notification feed, in accordance with various embodiments.

FIG. 4 is a process flow diagram illustrating a method of distributing brand notification information, in accordance with various embodiments.

FIG. 5 is a process flow diagram illustrating a method of updating a brand notification feed, in accordance with various embodiments.

FIGS. 6A-6C are exemplary screen displays illustrating a user interface for interacting with a user to update a brand notification feed, in accordance with various embodiments.

FIG. 7 is a generalized schematic diagram illustrating a computer system, in accordance with various embodiments of the invention.

FIG. 8 is a block diagram illustrating a networked system of computers, which can be used in accordance with various embodiments of the invention.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments may omit such features.

In an aspect, some embodiments provide tools and techniques for identifying brand misuse and/or for distributing information about such misuse. Such tools include, without limitation, systems, devices, methods, and software products (which can include one or more instructions that are encoded on a computer-readable medium and that can be used to program one or more computer systems to operate in accordance with various embodiments). Merely by way of example, one embodiment can be used to determine that a set of online content (e.g., a web site, web page, or portion thereof) is untrustworthy (for example, because that set of online content misuses a brand) and generate a brand notification feed indicating the untrustworthiness of the set of online content. This brand notification feed, in other embodiments, is distributed to a security vendor, who can incorporate information from the brand notification feed into the information it provides to clients (which typically, but not always, will be running on users' computers alongside, or within, web browsers). In this way, consumers can be warned before participating in a transaction with a web site that is not trustworthy.

In some cases, each set of online content is identified by a uniform resource locator (“URL”), such that the determination that a set of online content is trustworthy (or not) may be linked to the URL, such that a reference to the URL (e.g., a consumer's web browser downloading the content referenced by the URL) triggers an action by a security vendor's software (such as a pop-up warning, a notification in the “chrome” of the browser, etc.) to warn the consumer. In a novel aspect, this association of the (un)trustworthiness determination with the URL can provide finer granularity than merely associating the determination with a web site or a domain. (In some cases, the URL might reference an entire site, while in other cases, the URL might reference only a single web page, or even a portion of a web page, on the site.)

Merely by way of example, an otherwise legitimate online commerce site (such as Amazon.com™ or eBay.com™, to name two examples) might serve to host a set of online content (such as a microsite or an auction listing) that misuses a particular brand, without the knowledge of the operator of the online commerce site. By tying the brand notification to the URL that is specific to the illegitimate online content, rather than the entire web site or domain name itself, certain embodiments avoid implicating the other, legitimate content on the site. In addition, certain embodiments might, in addition to providing a brand notification to a security vendor, notify the operator of the online commerce site about the illegitimate content, so that the operator of the site can take any appropriate remedial action.

In a set of embodiments, the tools and/or techniques provide the ability for a brandowner to review the set of online content to confirm that the content is untrustworthy. Merely by way of example, as described in more detail below, certain embodiments provide a user interface to allow the brandowner (and/or an employee or representative thereof) to review the set of online content and provide user input indicating that the brandowner believes the set of online content to be infringing the brandowner's trademark(s) (or brand(s)), or that the set of content is otherwise to be considered untrustworthy. This feature can help to reduce false positives, which might occur relatively more frequently in totally automated systems. In another set of embodiments, the tools provide a mechanism for the brandowner to address disputes (in which the provider of the set of online content disputes that the content is untrustworthy), for example, by allowing the brandowner to indicate that an improper brand use in the content has been remediated, or that the brandowner continues to believe that the content is untrustworthy irrespective of the dispute by the siteowner, and/or by providing an updated brand notification feed indicating the same.

In accordance with further embodiments, the brand notification feed is provided by a brand notification computer system to a security vendor. In an aspect of other embodiments, a brand notification client (which typically is, but need not necessarily be, a software program installed on a computer maintained by the security vendor) is provided to mediate between the brand notification computer system and the security vendor, and/or the brand notification client may be configured to convert the brand notification feed into an exposed object (such as a Java object, to name one example) for use by the security vendor's computer system. In this way, the structure and/or nature of the brand notification feed itself may be obfuscated from the security vendor, providing enhanced security for the brand protection provider.

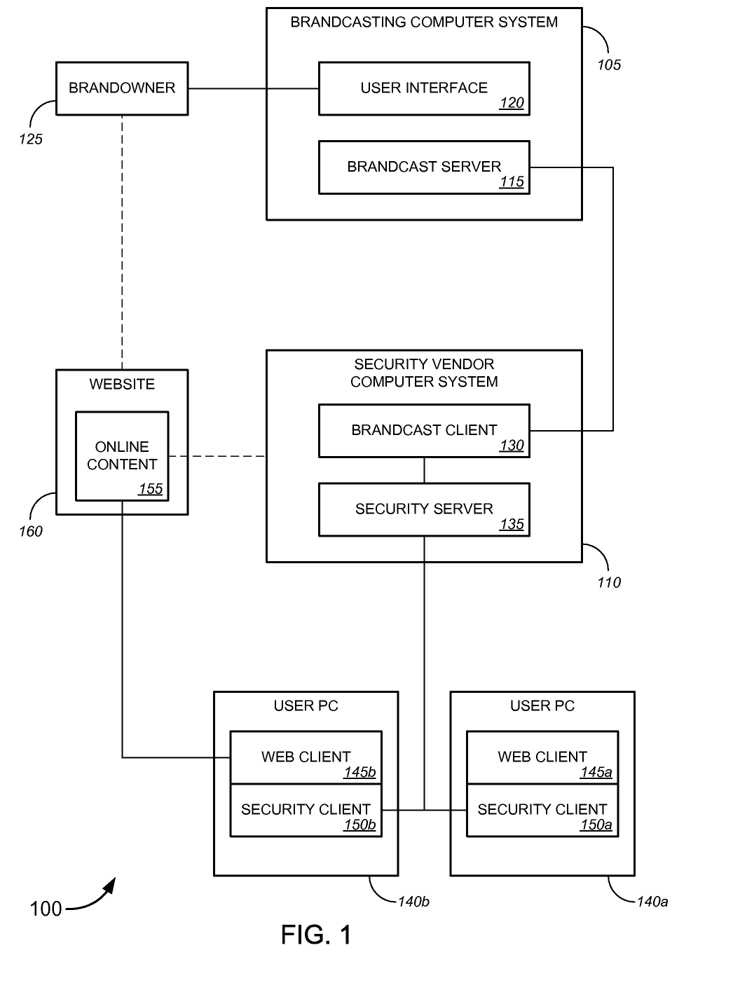

FIG. 1 illustrates a system 100 for providing information about online entities (including, without limitation, information about the trustworthiness of web sites and other online content), in accordance with a set of embodiments. Some embodiments might include the entirety of the system 100 illustrated by FIG. 1, while other embodiments might include only certain portions and/or components of the system 100.

The system 100 comprises a brand notification computer system 105 that is in communication with a security vendor computer system 110. In an aspect, the brand notification computer system 105 might be operated by a brand protection provider. In some cases, the brand protection provider might also provide other brand protection services, such as trademark enforcement, domain name enforcement, and/or the like, and the brand notification computer system might include functions for performing these services, in addition to the brand notification functions described herein. The security vendor computer system 110 might be operated by an online security provider. (In addition, while not pictured on FIG. 1, the brand notification computer system 105 might be in communication with multiple security vendor computer systems, each operated by a different online security provider.) The brand protection provider and the online security provider may be (but need not necessarily be) different commercial entities.

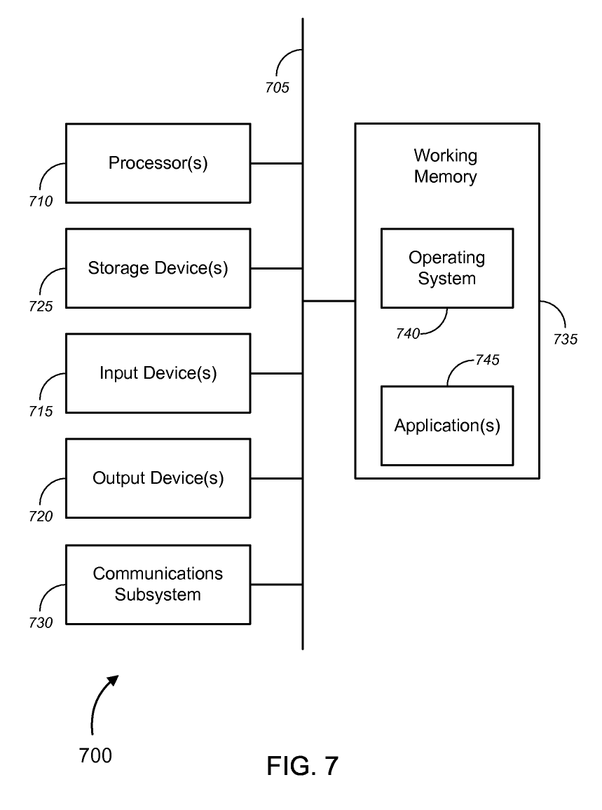

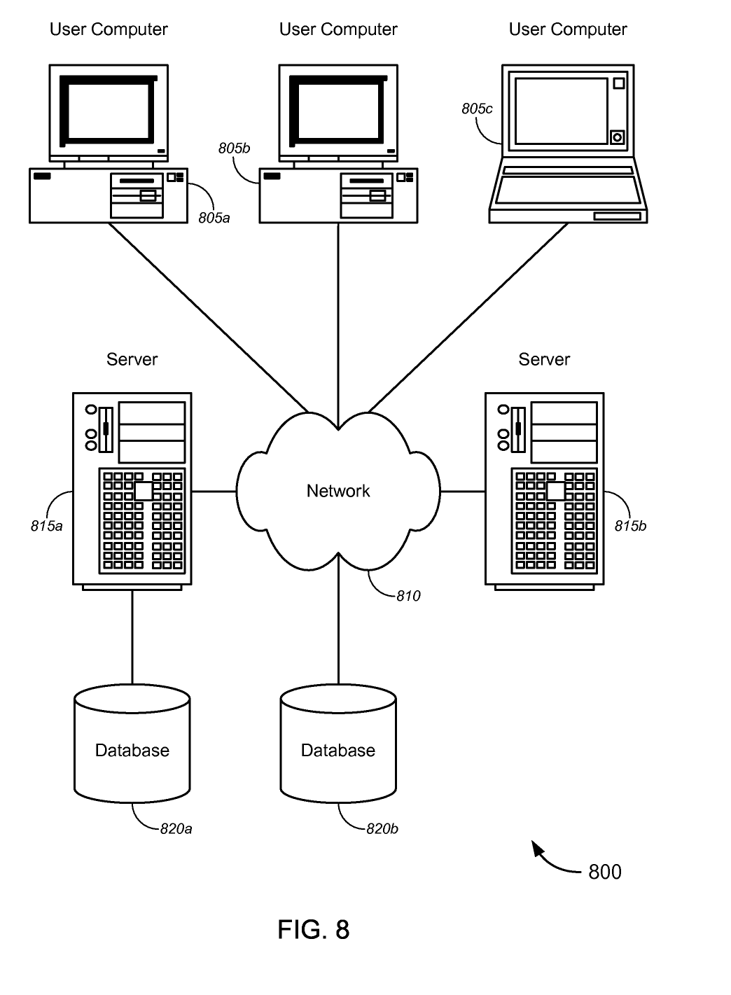

Each of these computer systems comprise, in accordance with some embodiments, one or more computers (which may be integrated and/or connected via a network) that are programmed with instructions to operate in accordance with the techniques provided by various embodiments, as described herein. FIGS. 7 and 8, described below, illustrate exemplary hardware configurations that may be used to implement the brand notification computer system 105 and/or the security vendor computer system 110. While a variety of functions are ascribed generally to the brand notification computer system 105 and/or the security vendor computer system 110, it should be understood that these functions may be performed individually by a plurality of computers incorporated within either the brand notification computer system 105 and/or the security vendor computer system 110. In other words, the arrangement of functionality between various computers within either the brand notification computer system 105 and/or the security vendor computer system 110 is discretionary and may vary in accordance with different embodiments.

In an aspect, the brand notification computer system 105 comprises a brand notification server 115 and a user interface 120. The user interface 120 allows users to interact with the brand notification computer system 105. A variety of user interfaces may be provided by the brand notification computer system 105, including without limitation graphical user interfaces that display, for a user, display screens for providing information to the user and/or receiving user input from a user. (Several examples of such display screens are described below.)

Merely by way of example, in some embodiments, the brand notification computer system 105 may be configured to communicate with a brandowner 125 (who typically will use a client computer) via a dedicated application running on the client computer; in this situation, the user interface 120 might be displayed by the client computer, based on data and/or instructions provided by the brand notification computer system 105. In other embodiments, the user interface for the brandowner 125 (or another user) may be provided from a web site that is incorporated within (and/or in communication with) the brand notification computer system 105, e.g., by providing a set of one or more web pages, which may be displayed in a web browser running on the client 125 and/or served by a web server (not shown on FIG. 1). Merely by way of example, the brand notification computer system 105 might comprise the web server and/or be in communication with the web server, such that the brand notification computer system 105 provides data to the web server to be served as web pages for display by a browser at the client computer operated by the brandowner 105 (or another user).

While the operation of these computer systems 105 and 110 (in accordance with certain embodiments) is described in further detail below, the brand notification computer system 105, in a general sense, is configured to identify brand misuse and/or other illegitimate content on the Internet. Any identified online content may be reviewed by the brandowner 125 (e.g., via the user interface 120), and if it is determined (based on a review by the brandowner 125 or otherwise) that a particular set of online content misuses one (or more) of the brandowner's 125 brands, or is otherwise untrustworthy for some reason (e.g., cybersquatting, phishing, pay-per-click advertising, etc.), the brand notification computer system 105 (and/or a component thereof) generates a brand notification pertaining to that set of online content.

As used herein, the term “brand notification” (sometimes referred to herein and in the figures as “brandcast”) means any type of notification about the trustworthiness of a set of online content. In a particular aspect, a brand notification can be related to a particular brand; in other words, the brand notification might contain information about a brand that the set of online content purports to relate to, although in other embodiments a brand notification might provide a notification that is independent of any particular brand. (Indeed, in certain embodiments, there need not be any finding that a set of online content misuses a particular brand in order to determine that the set of online content is untrustworthy; this determination might be made based on the set of online content (and/or other factors), without regard to whether a set of online content misuses any brands.) A brand notification can be negative, indicating that the set of online content is untrustworthy (e.g., that it misuses a particular brand, for example, as part of a phishing scheme, cybersquatting scheme, pay-per-client advertising scheme, counterfeit sales scheme, and/or the like), or positive, indicating that the set of online content is (or at least appears to be, from the perspective of the brandowner) trustworthy (e.g., that the set of online content properly uses a brand, is affiliated with the brandowner, etc.), or, in some cases neutral (e.g., indicating that the brand notification computer system 105 cannot determine whether the set of online content is trustworthy).

In some cases, a brand notification might merely indicate that a set of online content is or is not trustworthy; in other cases, the brand notification might include additional information (such as the brand to which the online content purports to relate, a reason for the trustworthiness determination, information about a dispute between the brandowner and a siteowner of the online content, etc.). In a particular aspect, the brand notification might include, as an identifier of the set of online content, a URL that references and/or describes the set of online content. In some cases, the brand notification might pertain to an entire web site and/or domain, while in other cases, the brand notification might pertain only to a set of web pages, a single web page, or even a portion of a web page. (In particular embodiments, the brandowner might be given the option of whether to apply a brand notification to an entire domain/website or only to one or more selected page(s) or portion(s) thereof.) Hence, a brand notification can distinguish between untrustworthy portions of a web site (or web page), and other portions of the web site/page that are legitimate.

In certain embodiments, the brand notification computer system (and/or a component thereof, such as a brand notification server 115) provides one or more brand notifications for consumption/reception by the security vendor computer system 110. In some cases, a brand notification feed is the vehicle used to provide the brand notification(s) to the security vendor computer system 110. Brand notification feeds are described in further detail below, but in general, a brand notification feed comprises one or more brand notifications (or information relating thereto). In some instances, each brand notification feed will comprise a single brand notification (i.e., information about a single set of online content), while in other cases a brand notification feed will comprise a plurality of brand notifications pertaining, perhaps, to a plurality of sets of online content. If a brand notification feed comprises a plurality of brand notifications, the organization and/or segmentation of brand notification feeds can vary according to various embodiments. Merely by way of example, in some embodiments, a brand notification feed comprises all currently active brand notifications produced by the brand notification computer system 105, while in other embodiments, a brand notification feed might comprise only new or updated brand notifications (which might be identified via a date sensitive query at the brand notification computer system 105). In an aspect, a brand notification feed is updated every time a new brand notification is created and/or updated. (In one sense, the update of a brand notification feed can be considered to be the generation of a new brand notification feed, which comprises updated brand notification information but which might also comprise any existing brand notification information that has not been updated or removed.)

In accordance with a set of embodiments, the brand notification server 115 provides the brand notification feed to the security vendor computer system 110. In some cases, the brand notification feed is provided as “push” service after generation and/or updated by the brand notification computer system 105. In other embodiments, however, the brand notification feed is provided as a “pull” service, in which the security vendor computer system 110 requests a brand notification feed from the brand notification server 115, and the brand notification server 115 transmits the brand notification feed in response to the request. In an aspect of some embodiments, this “pull” technique is similar to the well-known Really Simple Syndication (“RSS”) model, in which the security vendor computer system 110 subscribes to the brand notification feed. In an aspect, the brand notification feed may be formatted with a structured markup language, such as the eXtensible Markup Language (“XML”) and/or an extension or subset thereof. Merely by way of example, the brand notification feed might comprise one or more XML files which are formatted (e.g., tagged) in order to provide not only information about the set of online content deemed to be untrustworthy, but also metadata about that information, to ensure that the brand notification information is properly received and understood by the security vendor computer system 110.

The security vendor computer system 110 includes, in a set of embodiments, a brand notification client 130. In some embodiments, the brand notification client 130 is configured to request and/or receive a brand notification feed (e.g., from the brand notification server 115), while in other embodiments, the brand notification client 130 may not be necessary, and/or the brand notification feed may be requested/received by another component of the security vendor computer system 110.

In a set of embodiments, the brand notification client 130 is provided by the operator of the brand notification computer system 105 (e.g., a brand protection provider) and serves to mediate between the brand notification server 115 and the security vendor computer system 110. In some implementations, the brand notification client provides an exposed interface (e.g., an application programming interface, or “API”) that allows the security vendor computer system to interact programmatically with the brand notification client 130 (and/or, by extension, the brand notification server 115). Merely by way of example, the brand notification client 130 can serve as the subscriber for the brand notification feed, requesting new or updated brand notification feeds on a periodic basis. As another example, the brand notification client 130 can receive from the security vendor computer system 110 (or, more precisely, other software running on the security vendor computer system 110) requests for brand notification feeds and translate those requests as necessary before transmitting the requests to the brand notification server 115. Similarly, the brand notification client 130 may be configured to receive brand notification feeds from the brand notification server and provide information from those feeds for use by the security vendor computer system 110.

Merely by way of example, in one embodiment, the brand notification client 130 is a Java client that exposes a set of one or more Java objects (such as a JavaBean, a plain old Java Object (“POJO”) and/or the like) that are accessible by the security vendor computer system (through exposed methods, properties, etc.). The brand notification client 130, in one mode of operation, receives from the security vendor computer system requests for brand notification feeds; these requests are received as Java objects (or methods, etc.), and the brand notification client 130, in turn, generates a brand notification request (in the format required by the brand notification server 115) and transmits that request for reception by the brand notification server 115. Upon receiving one or more brand notification feeds in response to the brand notification request, the brand notification client 130 converts the brand notification feed(s) into one or more Java objects that are available for use by the security vendor computer system 110 (e.g., by calling exposed methods, etc.) In some cases, this conversion may include deserialization of the brand notification feed (and, correspondingly, a conversion of a Java object for communication from the brand notification client 130 to the brand notification server, as described below for example), might comprise serialization of the brand notification feed. The conversion process might further include encryption and/or obfuscation of the serialized data, as described in further detail below.

The security vendor computer system 110 may also include a security server 135, which provides security-related information to one or more user computers 140. Specifically, in certain embodiments, each user computer includes a web client 145 (which might be a web browser or any other program that is configured to provide interaction across a network, such as the Internet). The security server 135 might be configured to interact with each user computer 140, for example, through direct communication with the web client 145 and/or through communication with dedicated security client 150. The security client 150 might be implemented as a standalone program, a plug-in for the web client 145, and/or the like. Through the communication between the security server and the user computer 140, the user of the user computer can be informed of potential online security issues (such as child-safety issues, scams, etc.) on web sites visited by the user computer. Several such online security clients are commercially available, including merely by way of example McAfee Internet Security™ (available from McAfee, Inc.) and Norton Internet Security™ (available from Symantec Corporation).

In a set of embodiments, the security vendor computer system 110 is configured to incorporate information from one or more brand notification feeds into the data the security server 135 provides to the user computer(s) 145. In a novel aspect of certain embodiments, the transmission of the brand notification feed from the brand notification server 115 to the security vendor computer system 110 is facilitated by the brand notification client 130, as described above. Hence, in certain embodiments, once the security vendor computer system 110 has received the information from the brand notification feed, that information may be incorporated into the security vendor's online protection system, similar to other information (such as warnings about adult content, etc.) that might be used by that system.

Merely by way of example, when the web client 145b on a particular user computer 140b accesses (or attempts to access, depending on the security vendor's implementation) a set of online content 155 (which, in this example, might be a web page and/or a portion thereof) on a web site 160, the security client 150b on the user computer 140b might communicate with the security server 135 to determine whether any security warnings apply to the URL that identifies the set of online content 155. (Alternatively and/or additionally, the security client 150b might have downloaded beforehand from the security server 135 a file or set of files containing security warnings for a number of web sites.) If the set of online content 155 (e.g., as identified by its URL) is subject to a security warning, the web client 145b and/or the security client 150b displays a warning for the user and/or prevents the browser from accessing the web page.

To illustrate the implementation of brand notification in one such embodiment, consider a case in which the brand notification computer system 105 has determined that the set of online content 155 is an online auction that misuses a particular brand. The brand notification computer system 105 will generate a brand notification, which is provided to the security vendor computer system 110 (perhaps as part a brand notification feed), and the security vendor's security server 100 will provide relevant information from the brand notification feed to the security client 145b on the user computer 140b. If the user attempts to access the web page for the online auction, the web client 140b and/or the security client 145b will provide an appropriate warning. For instance, the security client 145 might trigger a popup window with the following warning: “WARNING: This web page contains an auction listing for a counterfeit item,” and/or the web client's chrome might display a warning icon, a warning label, and/or the like.

In some embodiments, the security vendor computer system 110 might also provide a notification to the siteowner that the set of online content 155 has been determined to be untrustworthy, as described in further detail below. (As used herein, the term “siteowner” can mean either the entity that owns or maintains the web site 160 on which the offending content 155 is found, or the entity responsible for the offending content 155, such as the listing entity for an auction on an auction site, or both.) This notification (which is represented by the broken line between the set of online content 155 and the security vendor computer system 110) might take the form of an active communication from the security vendor to the site owner, or might be more passive (such as inclusion in a published list of untrustworthy content, websites, URLs, and/or the like). Certain embodiments, as described more fully below, provide a mechanism to allow the brandowner 125 to address any disputes from the siteowner that the set of online content 155 is in fact untrustworthy, as described in further detail below.

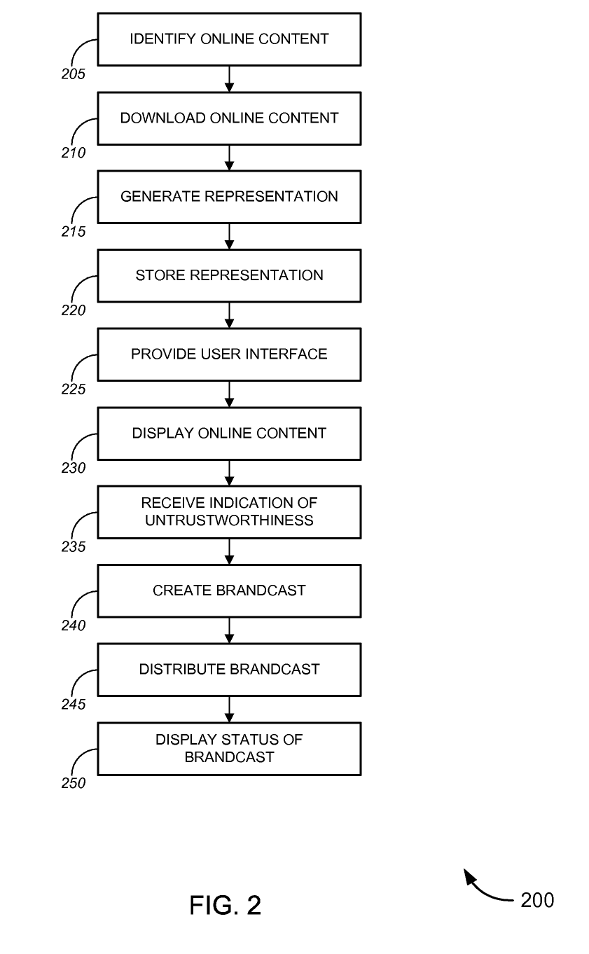

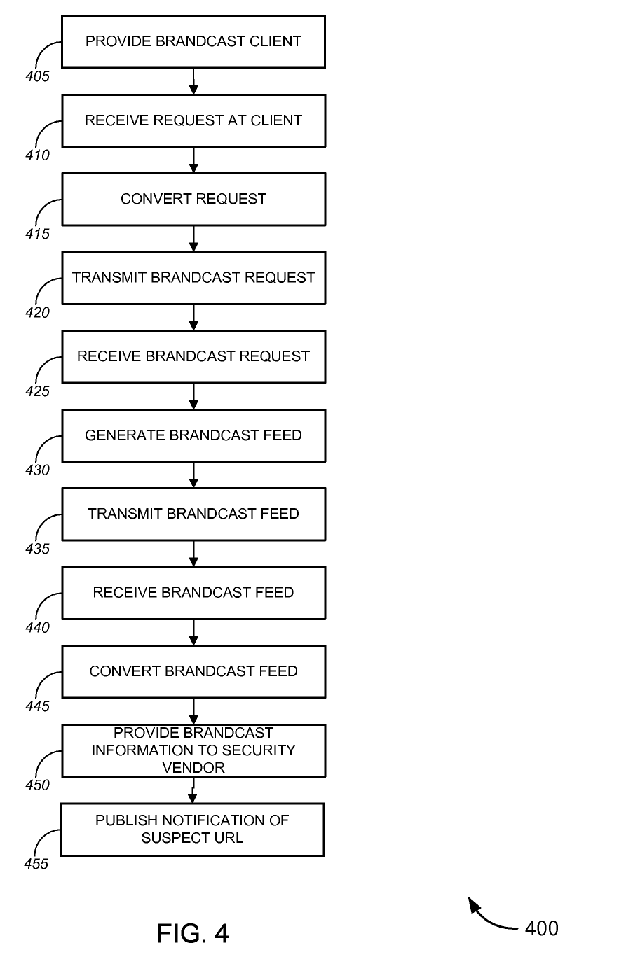

FIGS. 2, 4, and 5 illustrate various methods that can be used provide brand protection and/or notification services and/or otherwise inform users about untrustworthy online content. While the methods of FIGS. 2, 4, and 5 are illustrated, for ease of description, as different methods, it should be appreciated that the various techniques and procedures of these methods can be combined in any suitable fashion, and that, in some embodiments, the methods depicted by FIGS. 2, 4, and/or 5 can be considered interoperable and/or as portions of a single method. Moreover, while the methods illustrated by FIGS. 2, 4, and 5 can be implemented by (and, in some cases, are described below with respect to) a system similar to the system 100 of FIG. 1 (or components thereof), these methods can be implemented using any suitable hardware implementation. Similarly, while the system 100 of FIG. 1 (and/or components thereof) can operate according to the methods illustrated by FIGS. 2,4, and/or 5 (e.g., by executing instructions embodied on a computer-readable medium to perform operations in accordance with various procedures of these methods), the system 100 can also operate according to other modes of operation and/or perform other suitable procedures.

FIG. 2 illustrates a method 200 of generating a brand notification, in accordance with one set of embodiments. The method 200 comprises identifying a suspicious set of online content (block 205); that is, a set of online content that is considered likely (based on any of a variety of factors) to constitute misuse of a brand or otherwise be untrustworthy. As noted above, a set of online content is often identified by a URL that references the content, and identifying a suspicious set of online content may comprise identifying a URL of such content.

In certain embodiments, the brand notification system, and/or a component thereof, may be configured (e.g., programmed with appropriate computer-executable instructions) to identify a suspicious set of online content. A variety of tools and/or techniques can be used by the brand notification computer system, in accordance with various embodiments, to identify online content that is untrustworthy. To name but one example, the brandowner might provide to the brand notification computer system (e.g., via a user interface) a list of terms that represent brands (which might be registered and/or common law trademarks, service marks, and/or any other indicia of identification) that the brandowner considers to be its property. The brand notification computer system 105 (and/or a component thereof) might be configured to search and/or crawl (e.g., periodically and/or on demand) a variety of data sources, such as WHOIS records, auction listings, exchange sites (such as Amazon.com™ microsites), and/or the like using these provided terms and/or variations thereof (such as misspellings, words with common roots, etc.) as search criteria. If this crawling and/or searching activity reveals any online content (such as a domain name, web page, portion of a web page, etc.) that contains these terms, this online content may be further analyzed, for example by comparing the URL of the online content (and/or the domain/server on which the content resides) with a list of known domains, servers, and/or URLs that are affiliated with the brandowner. If the comparison reveals that the online content resides in a location affiliated with the brandowner, the online content might not be identified as suspicious, since it is likely that the online content has been provided (and/or approved) by the brandowner. On the other hand, if this comparison reveals no affiliation between the brandowner and the set of online content, the content may be identified as suspicious.

Additionally and/or alternatively, the brand notification computer system may implement any of a variety of content searching and/or analysis tools to identify suspicious online content. Merely by way of example, U.S. patent application Ser. No. 11/550,219, already incorporated by reference, describes several tools and techniques for determining whether a set of online content (e.g., a web page) authentically uses a particular brand. Any of such tools and/or techniques may be employed by the brand notification computer system, in accordance with certain embodiments.

Similarly, the following commonly-owned patents and patent applications, the relevant portions of which are incorporated herein by reference, describe tools and techniques for identifying illegitimate online activity: U.S. Pat. No. 7,346,605, issued Mar. 18, 2008 to Hepworth et al. and entitled “Method and System for Searching and Monitoring Internet Trademark Usage”; U.S. Pat. No. 7,457,823, issued Nov. 25, 2008 to Shraim et al. and entitled “Methods and Systems for Analyzing Data Related to Possible Online Fraud”; U.S. patent application Ser. No. 10/427,194, filed Apr. 30, 2003 by Shah et al. and entitled “Method and System to Correlate Trademark Data to Internet Domain Name Data”; U.S. patent application Ser. No. 10/709,398, filed May 2, 2004, by Shraim et al. and entitled “Online Fraud Solution”; U.S. patent application Ser. No. 10/996,991, filed Nov. 23, 2004, by Shraim et al. and entitled “Online Fraud Solution”; U.S. patent application Ser. No. 10/996,566, filed Nov. 23, 2004, by Shull et al. and entitled “Early Detection Of Online Fraud”; U.S. patent application Ser. No. 11/009,524, filed Dec. 10, 2004 by Bura et al. and entitled “Policing Internet Domains”; and U.S. patent application Ser. No. 11/009,531, filed Dec. 10, 2004 by Bura et al. and entitled “Analyzing Domain Ownership Information”; U.S. patent application Ser. No. 11/218,086, filed Aug. 31, 2005 by Hayward et al. and entitled “Systems For and Methods Of Alerting Users to the Trustworthiness of Web Sites and Web Pages”; U.S. patent application Ser. No. 11/339,985, filed Jan. 25, 2006 by Shull et al. and entitled “Online Identity Tracking”; U.S. patent application Ser. No. 11/368,372, filed Mar. 2, 2006 by Shull et al. and entitled “Trust Evaluation Systems and Methods”; U.S. patent application Ser. No. 11/428,072, filed Mar. 30, 2006 by Shull et al. and entitled “Enhanced Fraud Monitoring Systems”; U.S. patent application Ser. No. 11/620,429, filed Jan. 5, 2007 by Hayward et al. and entitled “Tagging and Tracking Devices Used to Commit Online Fraud”; U.S. patent application Ser. No. 11/670,291, filed Feb. 1, 2007 by Metois et al. and entitled “Detecting Online Abuse in Images”; U.S. patent application Ser. No. 11/685,311, filed Mar. 13, 2007 by Shull et al. and entitled “Domain Name Ownership Validation”; and provisional U.S. Patent Application No. 61/123,922, filed Apr. 10, 2008 by Horton et al. and entitled “Trademark Enforcement Systems and Methods.” Some or all of the tools and techniques described by these incorporated patents and applications may be used to identify suspicious online content.

The method 200, in some embodiments, further comprises downloading the suspicious set of online content (block 210), for example, to the brand notification computer system. These techniques may be used for a variety of reasons: For instance, in some cases, the suspicious content may be downloaded in order to preserve evidence of brand misuse. In other cases, the downloaded content may be displayed for a brandowner (and/or a representative thereof), as described in further detail below. In other embodiments, the method 200 comprises generating a representation of the suspicious online content (block 215) and/or storing (e.g., at the brand notification computer system and/or a storage device in communication therewith) the representation of the suspicious online content (block 220). In some cases, a downloaded copy of the set of online content may serve as a representation of the online content. In other cases, an identifier (such as a hash value, etc.) may be generated and/or used to represent the suspicious online content. Merely by way of example, a first hash value of a suspicious set of online content might be generated at a first point in time, and a second hash value of the suspicious online content might be generated at a second point in time. By comparing these hash values, the brand notification computer system can quickly determine whether the set of online content has been modified (for example, if the siteowner contends that the brand misuse has been remedied, but the hash value of the online content remains the same, that consistency might indicate that the brand misuse has not, in fact, been remedied).

The method 200, in the illustrated embodiment, further comprises providing a user interface to allow interaction between a user (e.g., a representative of a brandowner, an operator at the brand protection provider, etc.) and the brand notification computer system (block 225). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, keyboards (both numeric and alphanumeric), microphones, etc. The procedures undertaken to provide a user interface, therefore, can vary depending on the nature of the implementation; in some cases, providing a user interface can comprise displaying the user interface on a display device; in other cases, however, where the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device. Alternatively and/or additionally, the user interface on a client computer (or any other appropriate consumer device) might be a web interface, in which the user interface is provided through one or more web pages that are served from a computer system, such as a brandcast notification computer system (and/or a web server in communication with the computer system), and are received and displayed by a web browser on the client computer (or other capable consumer device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies.

In many cases, providing a user interface will comprise providing one or more display screens (a few examples of which are described below), each of which includes one or more user interface elements. As used herein, the term “user interface element” (also described as a “user interface mechanism”) means any text, image or device that can be displayed on a display screen for providing information to a user and/or for receiving user input. Such elements are commonly referred to as “widgets,” and can include, without limitation, text, text boxes, text fields, tables and/or grids, charts, hyperlinks, buttons, lists, combo boxes, checkboxes, radio buttons, and/or the like. While the exemplary display screens described herein employ specific user interface devices appropriate for the type of information to be conveyed/received by the brand notification computer system, it should be appreciated that the choice of user interface element for a particular purpose is typically implementation-dependent and/or discretionary. Hence, the illustrated user interface elements employed by the display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes any procedures for displaying (or otherwise providing) information to a user, or to receiving input from a user, the user interface may be the vehicle for the exchange of such input/output. Merely by way of example, in a set of embodiments, the user interface allows the user (e.g., the brandowner and/or a representative thereof) to review information about the identified set of online content.

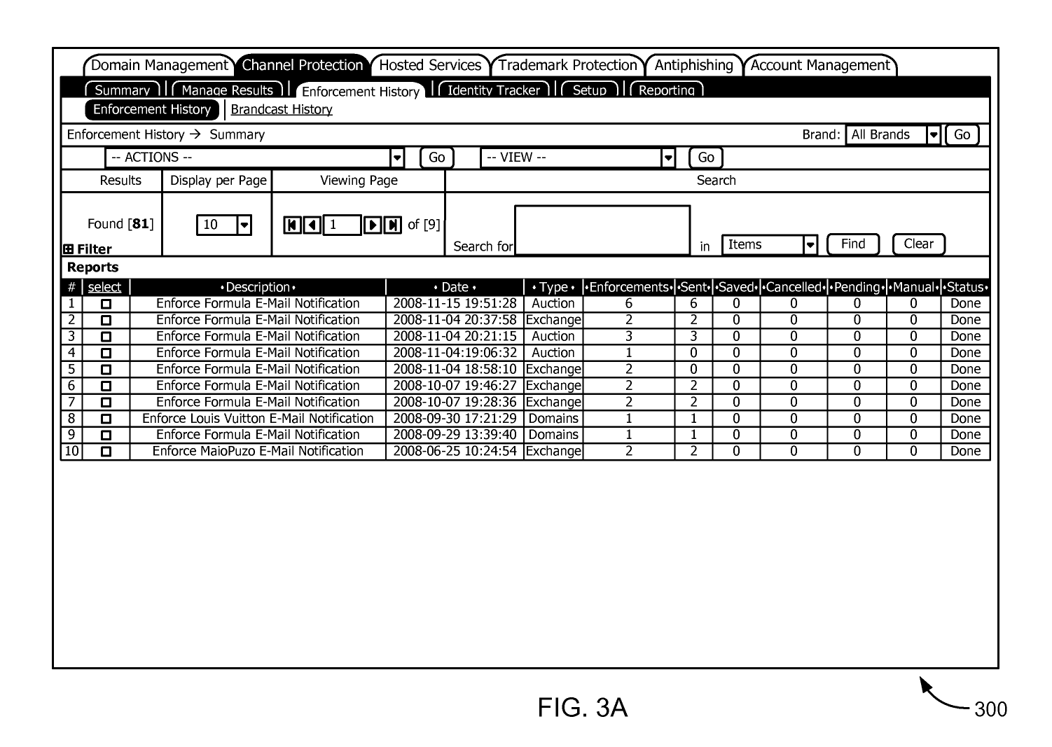

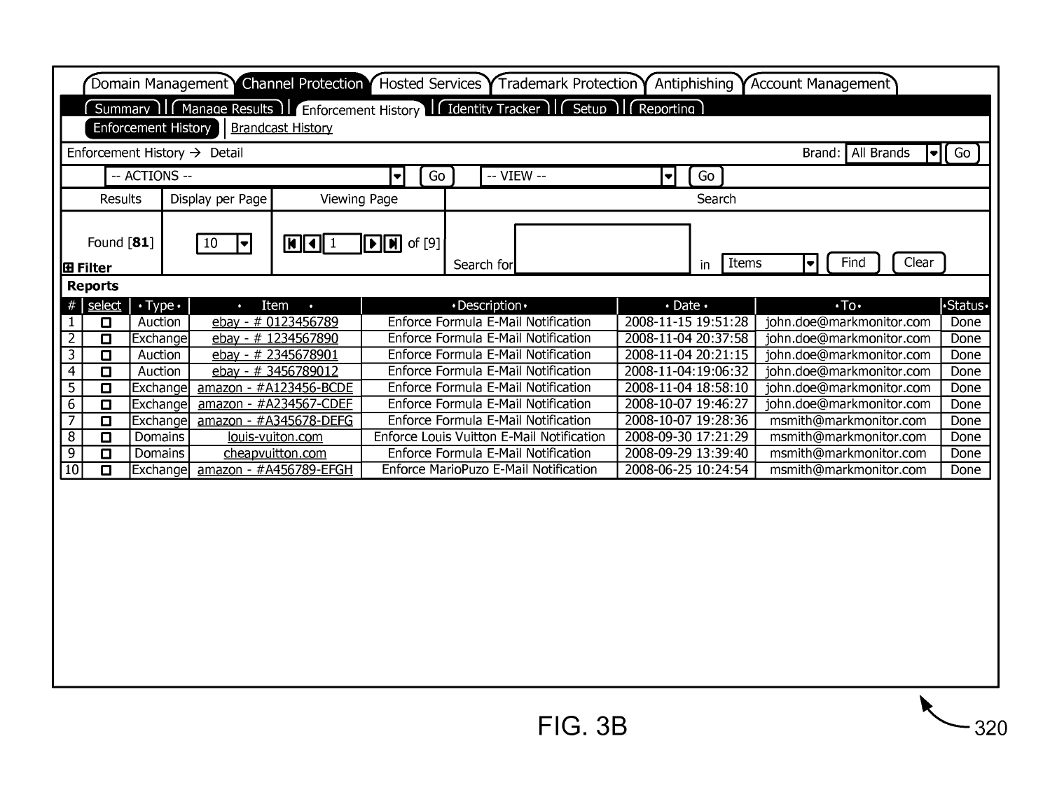

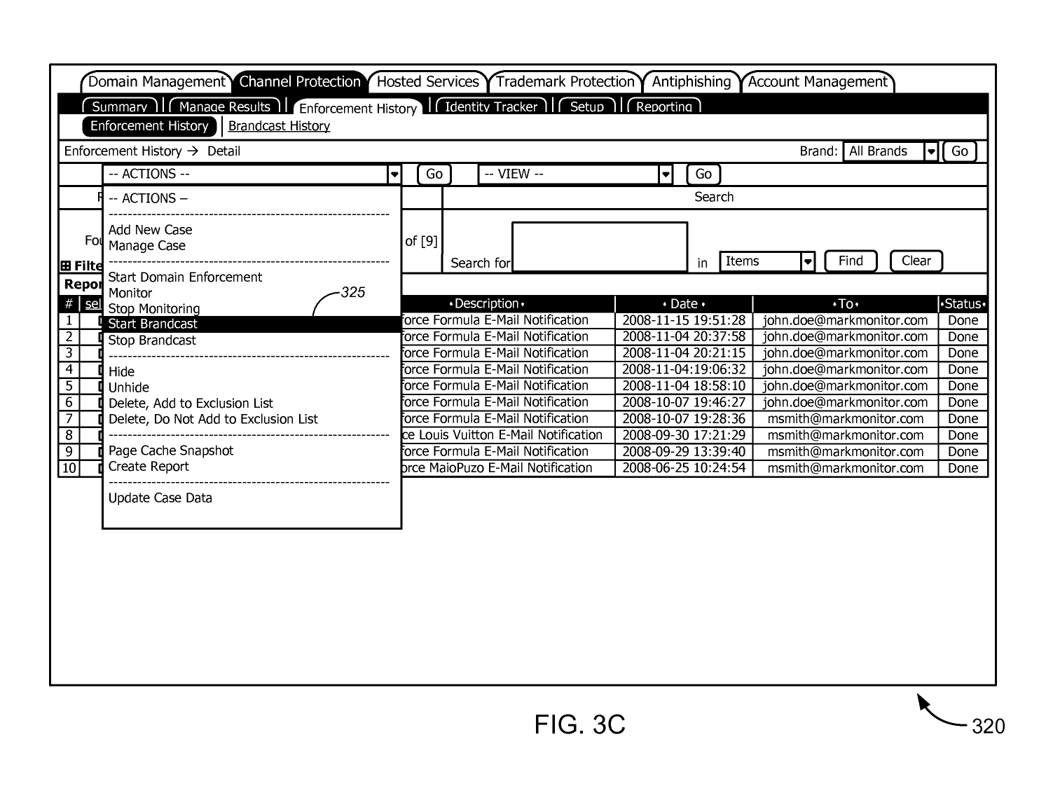

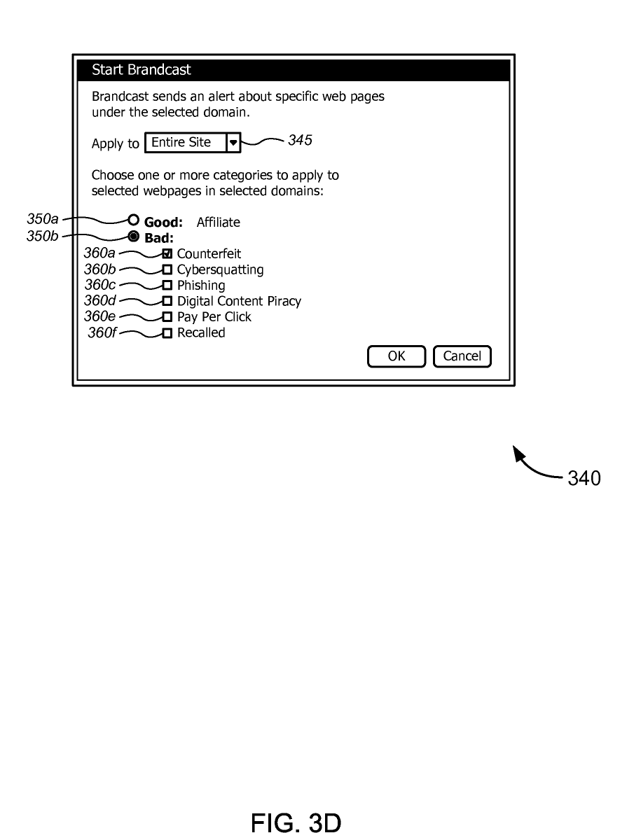

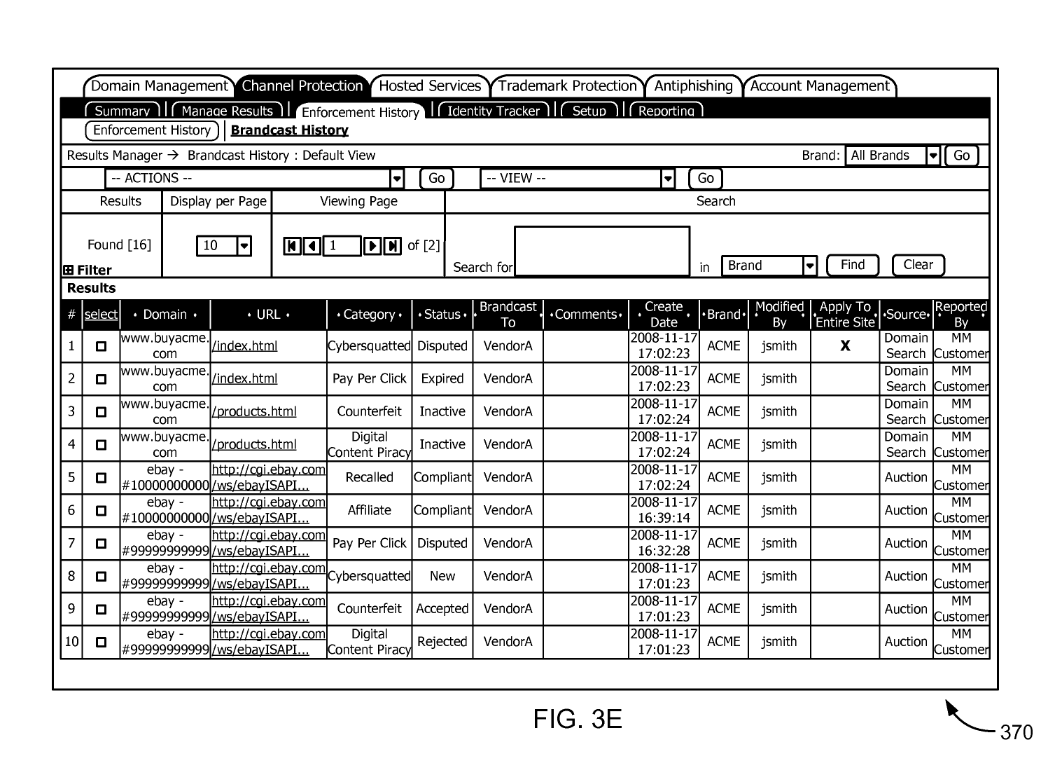

Merely by way of example, FIG. 3A illustrates an exemplary display screen 300 for displaying summary information about one or more suspicious web pages (or portions thereof) that have been identified by the brand notification computer system. The reader should note that the exemplary display screen 300 of FIG. 3A (like the other display screens described herein) is provided merely for demonstrative purposes and should not be considered limiting—various embodiments may employ any suitable design layout for display screens. Similarly, while the display screens illustrated by the figures employ particular user interface elements to allow for interactivity, the reader should appreciate that other elements may be substituted as appropriate in accordance with different embodiments.

The display screen 300 displays a list of “enforcement reports,” each of which represents a set of online content (e.g., a domain, a web page, a portion of a web, an online auction listing, an online exchange site, etc.). As illustrated by FIG. 3A, the list is organized in a grid or table format. Each enforcement report is represented by a row in the table, and the table also includes a header row comprising labels for each of a plurality of columns in the table. Each column contains values (as described by the column labels) for each respective enforcement report shown on the table. Merely by way of example, in the illustrated table, there are columns for displaying a sequence number of each enforcement report (column label “#”); a description of each enforcement report (column label “Description”); a date of each report (column label “Date”); the type of online content the report pertains to, such as auction, exchange, domain, etc. (column label “Type”), a number of enforcement actions taken against the online content (column label “Enforcements”), and the like. The table also includes a column with widgets (in this case, checkboxes) to allow the user to select one or more enforcement reports (column label “select”). In some embodiments, the rows on the table may be sortable by one or more characteristics of the reports and/or the content to which they pertain (e.g., by selection of the arrows in the column label of each column by which the table can be sorted). The screen 300 also includes a search interface to allow the user to search the enforcement reports for particular terms of interest, a “VIEW” menu to allow the user to select a different view of the enforcement actions, and an “ACTION” menu to allow the user to provide user input to instruct the brand notification computer system to take an action with respect to any selected enforcement reports.

In some cases, the user might prefer to view a more detailed description of the identified set(s) of online content. Accordingly, FIG. 3B illustrates an exemplary display screen 320 for displaying detailed information about one or more suspicious sets of online content. The detailed display is similar to the summary display 300 of FIG. 3A, except that the table shows different attributes for each enforcement report (i.e., each identified set of online content). In this display 320, the table includes the sequence number, selection, content type, and enforcement report description columns described above. In addition, the table includes a column displaying a description of the online content (content label “Item”). In the illustrated embodiment, the description of the online content is formatted as a hyperlink, which can be selected by the user to cause the brand notification computer system to display the online content (or a representation thereof), as described below. This can allow the user to view the online content to confirm that the online content is untrustworthy. The table further comprises a date column, which might contain values for the date the online content was identified, the date the last enforcement action was taken with respect to the online content, etc., as well as a column displaying contact information for a contact associated with the set of online content (column label “To”). In some embodiments, this column might display contact information for an operator at the brand protection provider who is responsible for the enforcement action. In other cases, this column might display contact information for an entity (such as a siteowner) responsible for the set of online content—this contract information might be obtained by the brand notification computer system, for example, from WHOIS records, contact information within the online content itself, and/or the like.

Returning to FIG. 2, the method 200 might further comprise displaying the identified set of online content for the user (block 230). In some cases, displaying the set of online content might comprise providing (e.g., in the user interface) and/or invoking a web browser and loading the set of online content, in situ, in the web browser. In other cases, displaying the set of online content might comprise displaying (in a web browser or otherwise), a representation of the set of online content, such as a downloaded and/or stored copy of the set of online content. In a particular aspect, the set of online content may be displayed upon request by the user. Merely by way of example, as noted above, in the exemplary display screen 320 of FIG. 3B, the item name for each set of suspicious online content (which, in some cases, is the URL, or a portion thereof, of the set of online content) might comprise a hyperlink, which, when selected by the user, will cause the brand notification computer system to display the set of online content via the user interface. By allowing the user to review the suspicious online content, the brand notification computer system provides the user with information to make an informed decision about whether the set of online content is untrustworthy (e.g., misuses the brandowner's brand).

The method 200 further comprises receiving, typically via the user interface, user input indicating that the identified set of online content improperly uses a brand owned by the brandowner (or is otherwise untrustworthy) (block 235). A variety of techniques can be used to receive this user input. Merely by way of example, FIG. 3C illustrates the display screen 320 of FIG. 3B, after the user has invoked the “ACTIONS” menu. This menu includes a variety of possible actions the user can take, including a menu item 325 that can be selected to provide user input instructing the brand notification computer system to start a brand notification pertaining to the identified set of online content. Selection of this menu item 325, in some embodiments, will cause the brand notification computer system to display, via the user interface, a display screen similar to the exemplary display screen 340 of FIG. 3D. This display screen 340 provides a widget 345 (in this case, a pick list) to allow the user to select whether the brand notification should apply to an entire domain (in the case of a dedicated counterfeit web site, for example), or merely to the identified URL (which might reference a specific auction on an otherwise legitimate auction site, for example). The display screen 345 also provides widgets 350a, 350b, respectively, to allow the user to indicate whether the identified set of online content is good (e.g., affiliated with the brandowner) or bad (e.g., untrustworthy). If the user indicates that the set of online content is bad, the user is provided with widgets from which to provide input about characteristics that justify the determination that the set of online content is untrustworthy (e.g., checkboxes 360a-f that can be selected to provide input indicating that the set of online content contains counterfeit products, constitutes an attempt to sell a product that has been recalled by the manufacturer, is an instance of cybersquatting, phishing, and/or digital content piracy, and/or employs pay-per-click advertising). Other embodiments may provide different options for the user to characterize the set of online content. By providing user input indicating that the content is “bad” and submitting the user input (e.g., using the “OK” button), the user provides an indication that the set of online content is untrustworthy and that a brand notification should be generated for this set of online content. (Alternately, the user might indicate that the content is “good”; in some cases, this indication might result in the creation of a positive brand notification about the set of online content; in other cases, there might be no brand notification created if the user indicates that the content is “good.”)

Thus, the brand notification computer system determines either that the set of online content misuses the brandowner's brand (or is otherwise untrustworthy) or that the set of online content is trustworthy (or, in some cases, perhaps, that it is unknown whether the set of online content is trustworthy). This determination may be based (at least in part) on the identification of the set of online content as being suspicious, the user input indicating that that the set of online content is (un)trustworthy, and/or other factors. Once this determination has been made, the brand notification computer system creates a brand notification (block 240) pertaining to that set of online content. As noted above, a brand notification is a set of data that provides a notification about the trustworthiness of a set of online content, and may be positive, negative, or, in some cases, neutral. Moreover, the brand notification may or may not include additional information about the set of online content and/or the brand that the set of online content (mis)uses, if applicable.

The method 200 further includes distributing the brand notification (block 245). A variety of techniques may be used to distribute the brand notification. Merely by way of example, in some cases, the brand notification computer system might publish one or more brand notifications. As another example, the techniques described in U.S. patent application Ser. No. 11/550,219, already incorporated by reference, may be used to distribute a brand notification. As another example, FIG. 4 (described below) illustrates various procedures that may be used to distribute a brand notification in accordance with various embodiments.

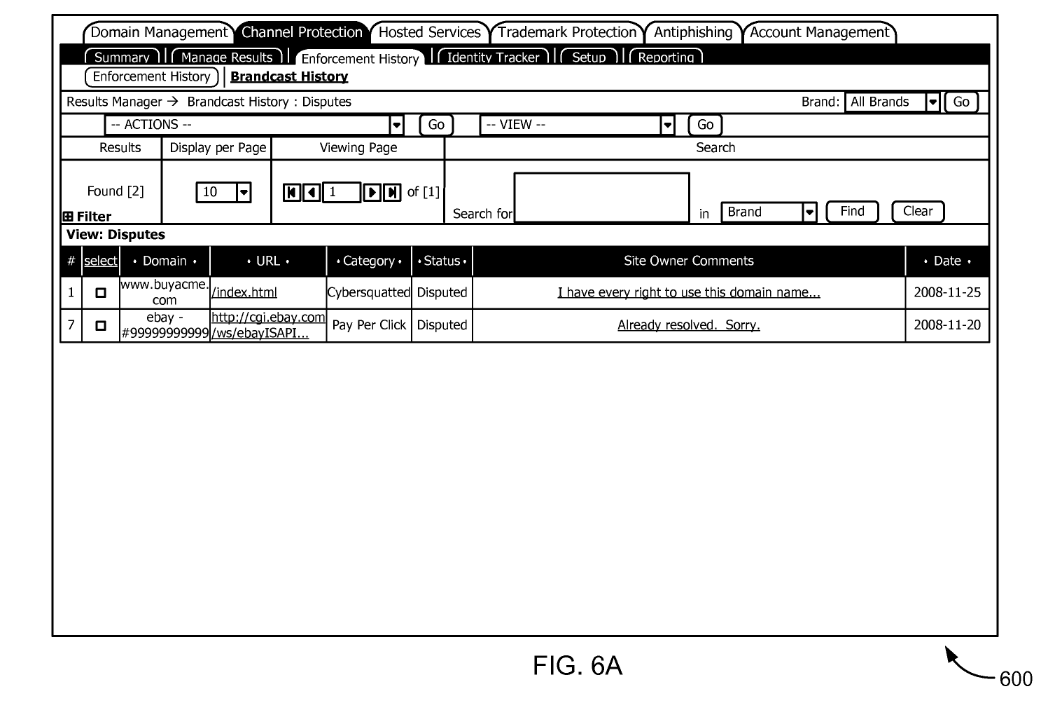

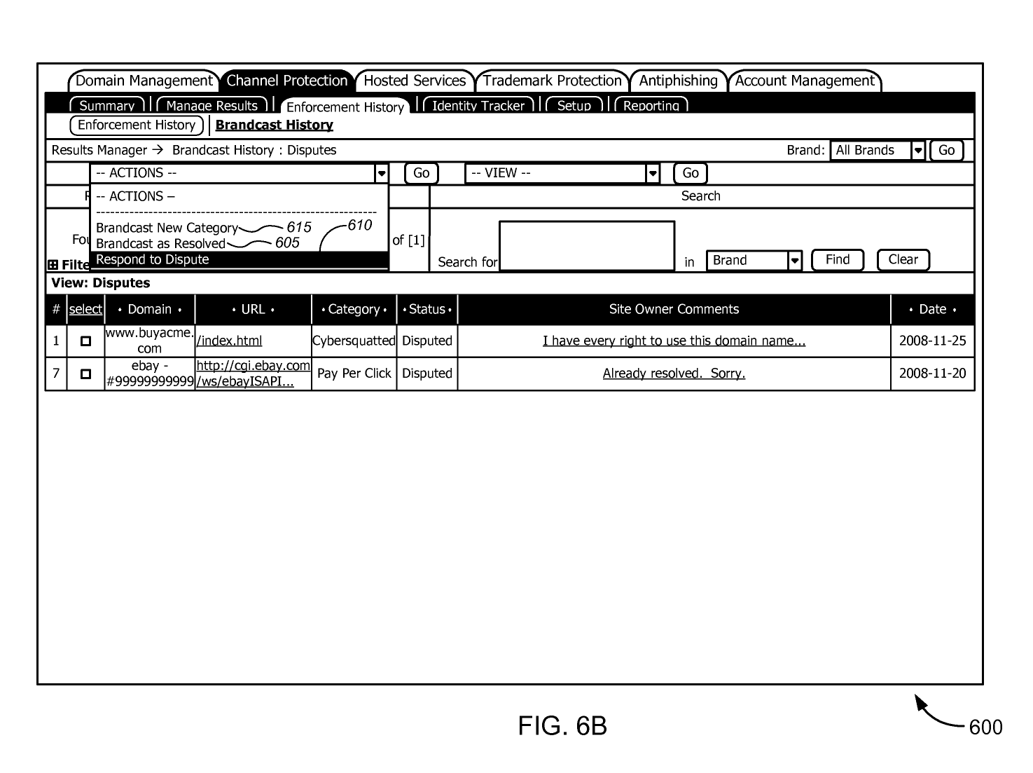

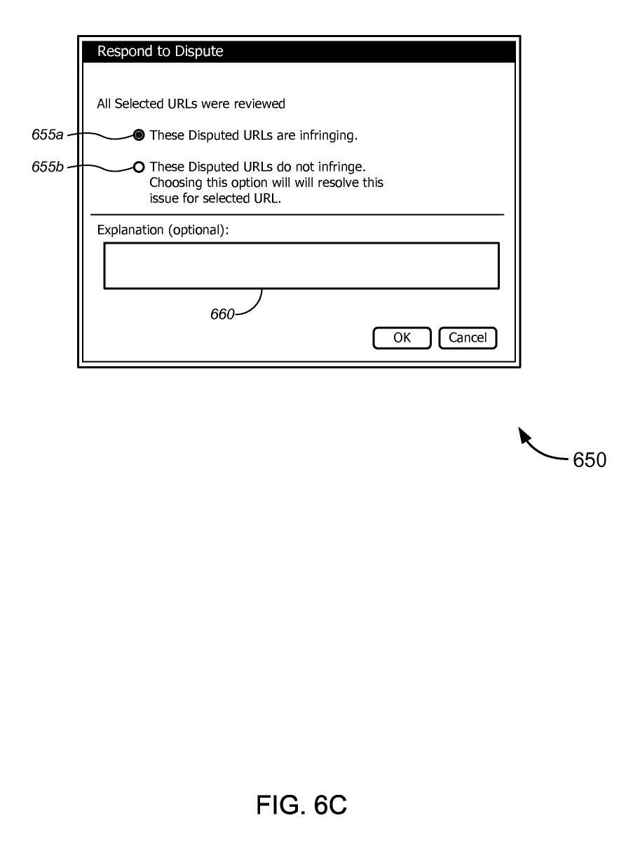

The method 200, in some cases, also comprises displaying (e.g., via a user interface) status information about the brand notification (block 250). This status information can include a variety of different types of information, and it serves to provide feedback to the user (e.g., a brandowner) indicating the status of the brand notification (e.g., that the brand notification has been created, distributed, disputed, resolved, and/or the like). Merely by way of example, FIG. 3E illustrates an exemplary display screen 370 that displays status information for several brand notifications. The exemplary screen 370 employs a layout similar to that of the screens 300 and 320 illustrated by FIGS. 3A and 3B, except that the screen 370 of FIG. 3E displays information about brand notifications, rather than merely about suspect online content; hence, each row in the table displayed by the screen 370 of FIG. 3E corresponds to a brand notification. Similarly, the “ACTIONS” menu might have different selectable actions (such as those of the “ACTIONS” menu displayed in FIG. 6B, described below).

Accordingly, the table displayed on the screen 370 provides somewhat different information. Merely by way of example, while the screen 370 provides the sequence number and selection columns similar to those of the previous screens 300 and 320, it includes additional information related to the brand notification. First, the table includes a column displaying, for each brand notification, a description of the set of online content (column label “domain”), which might be the name of the domain (if the set of online content is a domain), a listing or exchange identifier (for auctions or exchanges), a web page name (for web pages), etc. The table also includes a column displaying the URL that identifies the set of online content to which each brand notification pertains (column label “URL”). In the illustrated embodiment, the values in this column are formatted as hyperlinks that the user can select to cause the display of the online content.

The table might also include a column displaying the justification/reason for the brand notification (as provided by the brandowner, for example) that describes how or why the set of online content misuses a brand and/or is otherwise untrustworthy (column label “category”). In the embodiment illustrated by FIG. 3E, if a brandowner specifies multiple reasons/justifications for determining that a set of online content is untrustworthy, the brand notification computer creates a brand notification for each reason/justification (as shown by the brand notifications represented by rows 3 and 4, which each pertain to the same set of online content but provide a different category describing why the set of online content is untrustworthy, “Counterfeit” in the case of row 3, and ““Digital Content Piracy” in the case of row 4). Other embodiments might generate a single brand notification for each set of online content, irrespective of the number of reasons/justifications given for the brand notification (i.e. categories assigned to the set of online content), although each of the reasons/justifications might be included in the brand notification.

The table in screen 370 also includes a column displaying a status of each brand notification (column label “Status”). Any of a variety of status identifiers may be used, depending on the status of the brand notification. Merely by way of example, if a brand notification has been disputed (as described below, for example), the status of that brand notification might be set by the brand notification computer system to “disputed.” If the siteowner has reached agreement with the brandowner and the dispute has been resolved (as described below, for example), the status of the brand notification might be set to “compliant.”

In some cases, the brand notification computer system will determine the status of the brand notification based on a communication from the security vendor to which a brand notification was provided. Merely by way of example, in some embodiments, after receiving a brand notification feed, the security vendor will evaluate the brand notifications and determine whether the security vendor will accept the brand notifications for distribution via the security vendor's tools. The security vendor might then transmit a responsive communication (e.g., via a brand notification client) providing a response for each brand notification. Hence, if the brand notification has that has been received and/or accepted (e.g., used, distributed, etc.) by a security vendor, the status of the brand notification might be set to “accepted.” If the security vendor for some reason does not accept the brand notification, the status might be set as rejected. If a brand notification has not yet been distributed, the brand notification status might be set as “new.” In some cases, a brand notification might have an expiration date and/or time, after which the status is automatically set to “expired” (and/or the brand notification is no longer distributed). In other cases, if subsequent investigation reveals that the set of online content no longer exists, the status of the brand notification might be set to “inactive.” It should be appreciated that the status of a brand notification can have any number of values.

The table on display screen 370 also includes a column displaying identifiers of one or more security vendors (or other outlets) to whom the brand notification has been (or will be) distributed (column label “Brandcast To”); a column for comments (column label “Comments”), which can include comments from the brandowner, brand protection provider, security vendor, siteowner, or others; a column to display the creation date of each brand notification (column label “Create Date”); and a column for displaying any brand that is misused by the set of online content that is the subject of each brand notification (column label “Brand”). There may also be a column indicating whether the brand notification applies to the entire web site/domain (as opposed to a specific web pages or other content within the domain/web site) (column label “Apply to Entire Site”), and/or a column for displaying how each set of online content was identified, for example, by using the identification techniques described above, for example (column label “Source”). The table might also include a column for displaying an identification of the entity that requested the generation of each brand notification (column label “reported by”). In some cases, the value in the “reported by” field might be included in the distributed brand notification—if desired, the brandowner can provide its own identity (in which case the public and/or the siteowner might be informed that the brandowner is the entity objecting to the online content), or the brandowner can instruct the brand notification computer system to provide a generic identifier, such as “a MarkMonitor customer,” which would let the public and/or the siteowner know only that the brand protection provider generated the brand notification. The brandowner's selection between these two options might depend on whether the brandowner would prefer to be contacted directly with any disputes (from the siteowner or others) about the brand notification, or whether the brandowner would prefer that such contact be made through the brand protection provider.

FIG. 4 illustrates a method 400 for distributing brand notification information, in accordance with a set of embodiments. The method 400 may be used, for example, to distribute a brand notification generated in accordance with the method 200 of FIG. 2. The method 400, however, may also be used to distribute brand notifications generated by any other technique, or, for that matter, to distribute any type of syndicated information, including, but not limited to, information that relates to online security and/or verification of the trustworthiness of online content and/or online entities.

The method 400 comprises, in the illustrated embodiment, providing a brand notification client (block 405). As noted above, in an aspect, a brand notification client may be a software program that is configured to request, receive, and/or convert a brand notification feed (and/or other syndicated information). According to certain embodiments, the brand notification client is provided at a security vendor computer system, although the brand notification client could be provided on other systems as well (including server systems and/or client systems, such as user computers). Providing a brand notification client can comprise one or more of a variety of procedures, including without limitation creating a brand notification client, distributing a brand notification client (in either source code or object code format) to a security vendor (or another entity) for installation on a computer system, installing a brand notification client on a computer system, running a brand notification client on a computer system, and/or the like.

In a set of embodiments, the method 400 further comprises receiving a request for a brand notification feed (block 410). In some embodiments, the request is received at a brand notification client that has been provided at a security vendor computer system. As noted above, brand notification clients in accordance with certain embodiments are configured to provide an API comprising Java objects. Accordingly, receiving a request for a brand notification feed might comprise receiving the request as a Java object. In such embodiments, the method 400 further comprises converting (e.g., at the brand notification client) the Java object request into a brand notification request, which is formatted for transmission to a brand notification server (block 415). Since the brand notification server and the brand notification client interact, in some aspects, using communications formatted with a structured markup language, converting the request received at the brand notification client might comprise generating a brand notification request that is formatted for such communications (for example, as an HTTP GET request, a request formatted with a structured markup language (e.g., an XML message), and/or the like). As noted above, in some cases, converting the request might comprise serializing the Java object that includes the request, for transmission in an appropriate format and/or encrypting the request.

At block 420, the method 400 comprises transmitting a brand notification request for reception by a brand notification server. In some (but not necessarily all cases), the brand notification request will be transmitted from a brand notification client, and/or will be a brand notification request that has been converted from a Java object request, as described above. Typically, the brand notification request will be transmitted over a computer network, such as the Internet and/or the like, using standard transmission facilities. Merely by way of example, as noted above, a brand notification feed might employ techniques similar to RSS, and a brand notification request, therefore, might take a form similar to that of an RSS request (e.g., an HTTP GET request, an XML message, etc.). In some cases, the brand notification request might be encrypted and/or might require authentication at the brand notification server, in order to prevent unauthorized access to the brand notification feed.

The brand notification request is received at the brand notification server (block 425) and, after any appropriate decryption and/or authentication is performed, the brand notification server responds to the brand notification request. In some embodiments, responding to a brand notification request comprises generating a brand notification feed (block 430), while in other cases, the brand notification feed might be generated before any brand notification requests are received. (Merely by way of example, an updated brand notification feed might be generated every time a brand notification is created, modified, or deleted, and this pre-generated feed then would be used to respond to the brand notification request.) As noted above, in some embodiments, the brand notification request is a set of one or more XML files. These files may be encrypted or otherwise protected to prevent unauthorized access to the brand notification feed. Regardless of when or how generated, the brand notification feed may then be transmitted (block 435). Like the brand notification request, the brand notification feed may be transmitted over a computer network, using any appropriate technique. The brand notification feed, in an embodiment, is transmitted for reception by a brand notification client (e.g., a brand notification client operating on a security vendor computer system), while in other embodiments, the brand notification feed may be transmitted to any device that properly requests the brand notification feed (e.g., with appropriate authentication, if applicable), including without limitation other server computers, client computers, and/or the like.

The method 400 further comprises receiving the transmitted brand notification feed (block 440). In the instance in which a brand notification feed is transmitted to a brand notification client, the brand notification client, upon receiving the brand notification feed, may be configured to convert the brand notification feed for use by the computer system (e.g., a security vendor computer system) on which the brand notification client resides (block 445). Converting the brand notification feed for use by the computer system might comprise any necessary deserialization, decryption, format conversion, and/or the like to enable the brand notification client (and/or the computer system on which it resides) to use information from the brand notification feed. The brand notification information from the brand notification feed is then provided for use by the computer system on which the brand notification client resides (block 450). Merely by way of example, in the situation in which a brand notification client is running on a security vendor computer system, the brand notification client might convert the brand notification feed (and/or the brand notification(s) therein) to a set of one or more Java objects that are available to the security vendor computer and/or expose the Java objects for access by the security vendor computer system. In particular embodiments, the Java object(s) might take the form as a response to the Java object request that caused the brand notification client to initiate the brand notification request, and this Java object response might be provided for use by the security vendor computer system (block 450). For instance, the brand notification information, then, might be accessible to the security vendor computer system by way of an exposed interface to the Java object response (e.g., exposed methods, properties, etc.).

Hence, the brand notification information is made available for use by the computer system on which the brand notification client is running. In the case of a user computer, for example, this brand notification information might be used to provide warnings when the user requests a URL that is identified by a brand notification. As another example, in the situation in which the brand notification client is installed on a security vendor computer system, the brand notification information might be published by the security vendor computer system (block 455). Merely by way of example, a security server in the security vendor computer system might publish the brand notification information to one or more security clients served by the security server, similar to the way other online security information is published by the security server. This brand notification information can include some or all of the information from the brand notification, including without limitation, a notification that a URL is suspect (i.e., that the set of online content identified by the URL has been determined to be untrustworthy, etc.), an identification of a brand misused by the set of online content, a reason the online content has been determined to be untrustworthy, and/or the like. The security vendor computer system might further publish the information in a public forum (e.g., a web site maintained by the security vendor), such that it is accessible by the general public, or might provide the brand notification information to a siteowner responsible for the set of online content that is the subject of the brand notification and/or for the web site on which the content resides.

The siteowner, therefore, might become informed, in any of a variety of ways, that the set of online content has been determined to be untrustworthy. In some cases, the siteowner might dispute this determination (for example, because the siteowner mistakenly misused a brand—or allowed the misuse of the brand—and has subsequently remedied the misuse, or because the siteowner does not believe that it has misused the brand, or that the set of online content is not otherwise untrustworthy). Accordingly, some embodiments provide a mechanism for a brandowner to address a dispute by a site owner.

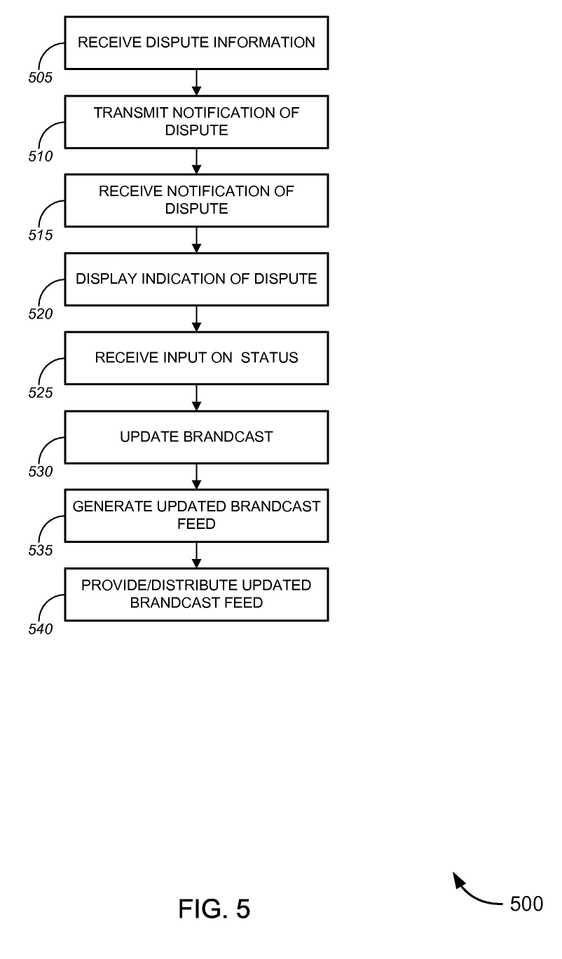

Merely by way of example, FIG. 5 illustrates a method 500 of updating a brand notification. The method 500 may be performed, for example, in response to receiving a dispute from a siteowner. At block 505, the method 500 comprises receiving dispute information from a siteowner associated with a set of online content that is the subject of a brand notification. The dispute information disputes that the set of online content misuses the brandowner's brand (or is otherwise untrustworthy). The dispute information might, in some cases, include a reason for the dispute and/or an explanation of the circumstances regarding the set of online content (such as an explanation for a (mis)use of the brandowner's brand, etc.). In some cases, the security vendor computer system will receive this dispute information, perhaps in response to publishing brand notification information about the set of online content. In other cases, the dispute information might be received at the brand notification computer system (for example, if the published brand notification information includes contact information for the brand protection provider).

If the dispute information is received at the security vendor computer system, the method 400 might include transmitting a notification (e.g., for reception by the brand notification computer system) that the siteowner disputes the brand notification (i.e., that the siteowner disputes that the set of online content is untrustworthy) (block 510). In an aspect of some embodiments, the notification is transmitted via the brand notification client operating on the security vendor computer system, for example accessing an API (which might be provided by one or more Java objects, similar to the technique described above by which the brand notification client receives a request for a brand notification). In such embodiments, the brand notification client converts and/or formats the notification (and/or any additional reason for the dispute or explanation provided by the siteowner) as necessary (e.g., by converting the notification to an XML message, etc.) and transmits the notification (and/or any additional information) for reception by the brand notification computer system (or a component thereof).

In accordance with some embodiments, the notification of the dispute is received (e.g., at the brand notification computer system) (block 515). The notification of the dispute might be received from the security vendor computer system, or from another source (such as direct contact from the siteowner, to name one example). The method 500 might also comprise displaying (e.g., via a user interface provided by the brand notification computer system) an indication that the siteowner disputes the brand notification (block 520). In some cases, this display might provide indications that a plurality of the brand notifications initiated by a particular brandowner have been disputed (perhaps by different siteowners).

By way of example, FIG. 6A illustrates an exemplary display screen 600 that might be provided by the brand notification computer system's user interface. The exemplary screen display 600 might have a layout similar to the display screens (in particular the display screen 370 of FIG. 3E) described above, except that the display might be limited to a list of disputed brand notifications. Additionally and/or alternatively, the table displayed by the screen 600 of FIG. 6A might be directed to information relevant to the dispute.

For instance, the table on the exemplary display screen 600 includes the sequence number, content description, URL, category and status fields similar to those of the table in the display 370 of FIG. 3E. (In the illustrated embodiment, each field in the URL column is formatted as a hyperlink, which the user can select to view the set of online content, or an updated representation thereof, to determine whether the brand notification is still valid for the set of online content.) Notably, for each row in the table, the status of the brand notification is “disputed.” The table on the screen 600 further includes a column (labeled “Date”) that displays, for each of the disputed brand notifications, a date on which notification of the dispute was received. In some embodiments, the screen 600 might also include a column (labeled “Site Owner Comments” in the illustrated embodiment) that displays any comments (e.g., explanations, etc.) provided by the siteowner—in the illustrated embodiment, a condensed version of each comment is displayed, and this condensed version is featured as a hyperlink that can be selected by the user to view the comment in its entirety.

In some cases, after being notified of the dispute (e.g., by viewing the displayed indication of the dispute), the brandowner might take steps to resolve the dispute. For example, the brandowner might contact the siteowner to discuss the issue (if desired, the brand notification computer system can provide an interface for the brandowner to communicate by email or otherwise with the site owner, or the brandowner might communicate independently), and the brandowner and siteowner might reach some agreement regarding the online content (for example, the siteowner might agree to remove or modify the offending content, in which case, the brandowner can provide input instructing the brand notification computer system to display obtain and/or display an updated representation of the set of online content, using techniques similar to those described above, to verify that the siteowner has complied with any agreement reached).

The brandowner might then wish to update the brand notification (either to stop a negative brand notification or to indicate that the set of online content remains untrustworthy even after an attempt to resolve a dispute over the brand notification). In this case, the brand notification computer system provides an interface for the user to provide an update to the brand notification (e.g., an indication of the current status of the set of online content), and the brand notification computer may receive, for example, via the user interface, user input indicating a status of the dispute and/or the brand notification (block 525). To illustrate this concept, FIG. 6B shows the display screen 600 of FIG. 6A, after the user has activated the “ACTIONS” menu. This menu provides options relevant to the brand casts. For example, the illustrated menu includes a menu item 605 that can be selected by the user to provide user input to instruct the brand notification computer system to update one or more selected brand notifications (which might be selected by checking the checkbox in the “select” column for the desired brand notification(s)) to indicate that the dispute has been resolved (e.g., that the siteowner has modified the set of online content to the brandowner's satisfaction, that the siteowner has persuaded the brandowner that the set of online content does not misuse the brandowner's brand, etc.). If the user selects this menu item, the brand notification computer system might update the selected brand notification(s) to indicate that the online content to which they pertain is compliant and/or that the dispute has been resolved, or the brand notification computer system might simply delete those selected brand notification(s) (or, in some cases, simply stop distributing those brand notifications).

In case the brandowner is not satisfied that the dispute has been resolved, the illustrated display screen 600 provides additional options. For example, the illustrated menu also includes a menu item 610 that is selectable to provide user input indicating that the user would like to update the brand notification to respond to the dispute (e.g., to provide a comment in response to the siteowner's comment). If the user selects this menu item, a display screen such as the exemplary display screen 650 of FIG. 6C might be displayed for the user. This display screen 650 provides a widget (in this case, a radio button 655a) for the user to provide input indicating either that the online content continues to be untrustworthy (and, optionally, a widget, such as text box 660 to add an explanation for the determination and/or responsive comment). The display screen 650 also includes a widget 655b for the user to provide input indicating that the online content is not untrustworthy. After receiving user input from this display screen 650, the brand notification computer system updates the selected brand notification(s) accordingly.

Returning to FIG. 6B, the illustrated menu also includes a menu item 615 that can be selected by the user to provide user input indicating that the user would like select a new category to assign to the set of online content, as the reason/justification for the brand notification. If the user selects this menu item, a display screen similar to the screen 340 of FIG. 3D might be displayed. After receiving user input from such as display screen, the brand notification computer system updates the selected brand notification(s) accordingly.

After receiving this user input, the brand notification computer system, in some embodiments, will update the brand notification, based at least in part on the user input (block 530). The procedure for updating a brand notification is similar to the procedure (described above) for generating a brand notification in the first instance. The updated brand notification might include any comments provided by the siteowner, as well as any responsive comments from the brandowner (if applicable). The brand notification computer system then generates an updated brand notification feed (block 535) and distributes the updated brand notification feed (block 540), as described above.

FIG. 7 provides a schematic illustration of one embodiment of a computer system 700 that can perform the methods provided by various other embodiments, as described herein, and/or can function as a computer within a brand notification computer system, a computer within a security vendor computer system, a user computer, and/or the like. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard and/or the like; and one or more output devices 720, which can include without limitation a display device, a printer and/or the like.

The computer system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 725. Volatile media includes, without limitation, dynamic memory, such as the working memory 735. Transmission media includes, without limitation, coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a storage device 725 either before or after execution by the processor(s) 710.

A set of embodiments comprises systems for generating, distributing, and/or updating brand notifications. Such systems can include, without limitation, brand notification computer systems and/or security vendor computer systems. Merely by way of example, FIG. 8 illustrates a schematic diagram of a system 800 that can be used in accordance with one set of embodiments. The system 800 can be seen as representing an exemplary hardware architecture for a brand notification computer system, a security vendor computer system, an interconnected system including both a brand notification computer system and a security vendor computer system, and/or the like. The system 800 can include one or more user computers 805. The user computers 805 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 805 can also have any of a variety of applications, including one or more applications configured to perform methods provided by various embodiments (as described above, for example), as well as one or more office applications, database client and/or server applications, and/or web browser applications. Alternatively, the user computers 805 can be any other electronic device, such as a thin-client computer, Internet-enabled mobile telephone, and/or personal digital assistant, capable of communicating via a network (e.g., the network 810 described below) and/or displaying and navigating web pages or other types of electronic documents. Although the exemplary system 800 is shown with three user computers 805, any number of user computers can be supported.

Certain embodiments of the invention operate in a networked environment, which can include a network 810. The network 810 can be any type of network familiar to those skilled in the art that can support data communications using any of a variety of commercially available (and/or free or proprietary) protocols, including without limitation TCP/IP, SNA, IPX, AppleTalk, and the like. Merely by way of example, the network 810 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 may be a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 805 and/or another server 815. In some embodiments, an application server can create web pages dynamically for displaying the information in accordance with various embodiments, such as providing a user interface for a user (such as a brandowner or its representative) to interact with a brand notification computer system, to name one example. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: Merely by way of example, a database 820a might reside on a storage medium local to (and/or resident in) a server 815a (and/or a user computer 805). Alternatively, a database 820b can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 835 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system for providing information about online entities, the system comprising:
a brand notification computer system comprising a first processor and a first computer-readable medium having encoded thereon a first set of instructions executable by the brand notification computer system to perform one or more operations, the first set of instructions comprising:
instructions for identifying a suspicious set of online content, the set of online content being identified by a uniform resource locator (“URL”);
instructions for providing a user interface for a user to review information about the set of online content, wherein the user interface comprises a user interface mechanism for the user to indicate that the set of online content improperly uses that improperly uses a brand owned by a brandowner;
instructions for displaying the set of online content for the user;
instructions for receiving, via the user interface, first user input indicating that the set of online content improperly uses the brand;
instructions for generating a brand notification indicating that the set of online content includes an improper brand usage, based at least in part on the first user input, wherein the brand notification comprises an identification of the URL, an identification of the brand, an identification of the brandowner, and an indication of a category describing how the set of online content improperly uses the brand, the brand notification feed being formatted with a structured markup language;
instructions for generating a brand notification feed comprising the brand notification;
instructions for providing the brand notification feed upon request from a brand notification client software program at a security vendor computer system; and
instructions for displaying, via the user interface, status information about the brand notification;
a security vendor computer system comprising a second processor and a second computer-readable medium having encoded thereon a second set of instructions executable by the security vendor computer system to perform one or more operations, the second set of instructions comprising:
instructions for receiving, at a brand notification client software program, a Java object requesting the brand notification feed from the brand notification computer system;
instructions for converting the Java object request into a brand notification request at the brand notification client software program;
instructions for transmitting the brand notification request from the brand notification client software program for reception by the brand notification computer system;
instructions for receiving, at the brand notification client software program, the brand notification feed from the brand notification computer system;
instructions for converting, at the brand notification client software program, the brand notification feed to a Java object response available to the security vendor computer system, the Java object response comprising information from the brand notification feed;
instructions for providing the Java object response, from the brand notification client software program, for use by the security vendor computer system;
instructions for publishing, from the security vendor computer system and to one or more security clients on user computers, a notification that the URL is suspect, based at least in part on the information from the brand notification feed;
instructions for receiving, from a siteowner associated with the set of online content, information disputing that the set of online content includes an improper brand usage; and
instructions for transmitting, via the brand notification client software program, a notification that the siteowner disputes that the set of online content includes an improper brand usage;
wherein the first set of instructions further comprises:
instructions for receiving the notification;
instructions for displaying, via the user interface, an indication that the siteowner disputes that the set of online content includes an improper brand usage;
instructions for receiving, via the user interface, second user input indicating a status of the set of online content;
instructions for updating the brand notification, based at least in part on the second user input;
instructions for generating an updated brand notification feed comprising the updated brand notification;
and
instructions for providing the updated brand notification feed upon request from the brand notification client software program at the security vendor computer system.

2. A method, comprising:
determining, at a computer system, whether a set of online content is untrustworthy;
generating, at the computer system, a brand notification indicating whether the set of online content is untrustworthy, wherein the brand notification comprises an identification of the set of online content; and
distributing the brand notification.

3. The method of claim 2, wherein determining whether a set of online content is untrustworthy comprises determining that the set of online content is trustworthy.

4. The method of claim 3, wherein determining that the set of online content is trustworthy comprises determining that the set of online content is affiliated with a brand owned by a brandowner.

5. The method of claim 4, wherein determining that the set of online content is affiliated with a brand owned by a brandowner comprises receiving user input indicating that the set of online content is affiliated with the brand.

6. The method of claim 2, wherein determining whether a set of online content is untrustworthy comprises determining that the set of online content is untrustworthy.

7. The method of claim 6, wherein determining that the set of online content is untrustworthy comprises determining that the set of online content improperly uses a brand.

8. The method of claim 7, wherein the brand notification indicates that the set of online content is untrustworthy by indicating that the set of online content improperly uses a brand.

9. The method of claim 6, further comprising:
receiving, at the computer system, a notification that a siteowner associated with the set of online content disputes that the set of online content is untrustworthy;
displaying, via the user interface, an indication that the siteowner disputes that the set of online content is untrustworthy;
receiving, via the user interface, second user input indicating a status of the set of online content;
generating an updated brand notification based at least in part on the second user input; and
distributing the updated brand notification.

10. The method of claim 2, wherein the set of online content comprises at least a portion of a web page.

11. The method of claim 10, wherein the web page is an online commerce web page.

12. The method of claim 11, wherein the set of online content is a sales listing on the online commerce web page.

13. The method of claim 12, wherein the web page comprises, in addition to the set of online content, one or more legitimate sales listings.

14. The method of claim 13, wherein the brand notification distinguishes the set of online content from the one or more legitimate sales listings.

15. The method of claim 2, wherein the set of online content is identified by a uniform resource locator (“URL”), and wherein the identification of the set of online content comprises an identification of the URL.

16. The method of claim 2, wherein determining whether a set of online content is untrustworthy comprises:
identifying a set of suspicious online content;
providing, from the computer system, a user interface for a user to review information about the set of online content, wherein the user interface comprises a user interface mechanism for the user to indicate whether the set of online content is untrustworthy;
receiving, via the user interface, first user input indicating whether the set of online content is untrustworthy.

17. The method of claim 16, wherein determining w a set of online content is untrustworthy further comprises:
displaying, for the user, the set of online content.

18. The method of claim 17, further comprising:
generating a representation of the set of online content; and
storing the representation of the set of online content.

19. The method of claim 18, wherein displaying the set of online content comprises displaying, in the user interface, the representation of the set of online content.

20. The method of claim 2, wherein distributing the brand notification comprises:
generating a brand notification feed comprising the brand notification; and
transmitting the brand notification feed.

21. The method of claim 20, wherein the brand notification feed comprises a plurality of brand notifications, each of the plurality of brand notifications pertaining to a separate set of online content.

22. The method of claim 20, wherein the brand notification feed is formatted with a structured markup language, the method further comprising:
providing, at a security vendor computer system, a brand notification client software program for receiving the brand notification feed;
requesting, at the brand notification client software program, the brand notification feed;
receiving the brand notification feed at the brand notification client; and
providing information from the brand notification feed to the security vendor using an exposed interface, such that the brand notification feed formatted in the structured markup language is not accessible by the security vendor.

23. A computer system, comprising:
a processor; and
a computer-readable medium having encoded thereon a set of instructions executable by the computer system, the set of instructions comprising:
instructions for determining whether a set of online content is untrustworthy;
instructions for generating a brand notification indicating whether the set of online content is untrustworthy; wherein the brand notification comprises an identification of the set of online content; and
instructions for distributing the brand notification.

24. An apparatus, comprising:
a computer-readable medium having encoded thereon a set of instructions executable by a computer system, the set of instructions comprising:
instructions for determining whether a set of online content is untrustworthy;
instructions for generating a brand notification indicating whether the set of online content is untrustworthy, wherein the brand notification comprises an identification of the set of online content; and
instructions for distributing the brand notification.

25. A method, comprising:
determining, at a first computer system, that a set of online content is untrustworthy, the set of online content being identified by a uniform resource locator (“URL”);
providing, at a second computer system, a brand notification client software program for receiving a brand notification feed from the first computer system;
generating, at the first computer system, a brand notification feed indicating that the set of online content is untrustworthy, wherein the brand notification feed comprises an identification of the URL and an indication of a category describing how the set of online content is untrustworthy, the brand notification feed being formatted with a structured markup language;
transmitting the brand notification feed from first computer system;
receiving the brand notification feed at the brand notification client; and
providing information from the brand notification feed to the second computer system using an exposed interface, such that the brand notification feed formatted in the structured markup language is not accessible by an operator of the second computer system.

26. A system, comprising:
a first computer system, comprising:
a processor; and
a computer-readable medium having encoded thereon a first set of instructions executable by the first computer system to perform one or more operations, the first set of instructions comprising:
instructions for determining that a set of online content is untrustworthy, the set of online content being identified by a uniform resource locator (“URL”);
instructions for generating a brand notification feed indicating that the set of online content is untrustworthy, wherein the brand notification feed comprises an identification of the URL and an indication of a category describing how the set of online content is untrustworthy, the brand notification feed being formatted with a structured markup language;
instructions for transmitting the brand notification feed from the brand notification computer system; and
a brand notification client software program operating on a second computer system, the brand notification client software program comprising a second set of instructions executable by the second computer system, the second set of instructions comprising:
instructions for receiving the brand notification feed; and
instructions for providing information from the brand notification feed to the second computer system using an exposed interface, such that the brand notification feed formatted in the structured markup language is not accessible by an operator of the second computer system.

27. An apparatus, comprising:
a first computer-readable medium having encoded thereon a set of instructions executable by a first computer system, the first set of instructions comprising:
instructions for determining that a set of online content is untrustworthy, the set of online content being identified by a uniform resource locator (“URL”);
instructions for generating a brand notification feed indicating that the set of online content is untrustworthy, wherein the brand notification feed comprises an identification of the URL and an indication of a category describing how the set of online content is untrustworthy, the brand notification feed being formatted with a structured markup language;
instructions for transmitting the brand notification feed; and
a second computer-readable medium having encoded thereon a brand notification client software program, the brand notification client software program comprising a second set of instructions executable by a second computer system, the second set of instructions comprising:
instructions for receiving the brand notification feed; and
instructions for providing information from the brand notification feed to the second computer system using an exposed interface, such that the brand notification feed formatted in the structured markup language is not accessible by an operator of the second computer system.
